(19) United States
(12) Patent Application Publication
(10) Pub. No.: US 2026/0198550 A1
(43) Pub. Date: Jul. 16, 2026

(54) AEROSOL-GENERATING ARTICLE CONFIGURED FOR ENHANCED FLAVOUR DELIVERY

(71) Applicant: Philip Morris Products S.A., Neuchatel (CH)

(72) Inventors: Anneke GLABASNIA, Murten (CH); Jérôme Jean-Yves GIRARD, Chemin de Pierrefleur 3 (CH); Emmanuel Gérard René ROUGET, Fontaines (CH)

(73) Assignee: Philip Morris Products S.A., Neuchatel (CH)

(21) Appl. No.: 19/113,011

(22) PCT Filed: Sep. 27, 2023
(86) PCT No.: PCT/EP2023/076760

§ 371 Date: Mar. 19, 2025

(30) Foreign Application Priority Data
Sep. 29, 2022 (EP) 22198837.1

(51) Int. Cl. A24D 1/20; A24B 15/12; A24B 15/40; A24D 1/00; A24D 1/02; A24F 40/20; A24F 40/465; H05B 6/36

(52) U.S. Cl. CPC A24D 1/20; A24B 15/12; A24B 15/403; A24D 1/002; A24D 1/027; A24F 40/20; A24F 40/465; H05B 6/36

(57) ABSTRACT

An aerosol-generating article for generating an aerosol upon heating is provided, the article including: an aerosol-generating element including a rod of aerosol-generating substrate circumscribed by a wrapper; a downstream section provided immediately downstream of the element and extending from a downstream end of the element to a downstream end of the article; an upstream section provided immediately upstream of the element and extending from an upstream end of the element to an upstream end of the article, the upstream section including an upstream element formed from a tow of cellulose acetate fibres; pieces of a flavour material combined into the tow, the flavour material including: a polysaccharide matrix structure including gellan gum and emulsifier, and a flavourant formulation dispersed within the matrix structure, and the flavourant formulation being at least partly trapped within the matrix structure and releasable from the matrix structure upon heating of the flavour material.

The present disclosure relates to a flavour material for use in an aerosol-generating article. Further, the present disclosure relates to aerosol-generating articles comprising one such flavour material.

Aerosol-generating articles in which an aerosol-generating substrate, such as for example a tobacco-containing substrate or a non-tobacco, nicotine-containing substrate, is heated rather than combusted, are known in the art. Typically, in such heated smoking articles an aerosol is generated by the transfer of heat from a heat source to a physically separate aerosol-generating substrate or material, which may be located in contact with, within, around, or downstream of the heat source. During use of the aerosol-generating article, volatile compounds are released from the aerosol-generating substrate by heat transfer from the heat source and are entrained in air drawn through the aerosol-generating article. As the released compounds cool, they condense to form an aerosol.

Several aerosol-generating devices for consuming aerosol-generating articles have been disclosed in the art. Such devices include, for example, electrically heated aerosol-generating devices in which an aerosol is generated by the transfer of heat from one or more electrical heater elements of the aerosol-generating device to the aerosol-generating substrate of an aerosol-generating article. For example, electrically heated aerosol-generating devices have been proposed that comprise an internal heater blade which is adapted to be inserted into the aerosol-generating substrate. As an alternative, inductively heatable aerosol-generating articles comprising an aerosol-generating substrate and a susceptor arranged within the aerosol-generating substrate have been proposed by WO 2015/176898.

It has been proposed in the past to include in aerosol-generating articles a source of flavour in addition to the aerosol-generating substrate. In effect, this practice was relatively common with conventional filter cigarettes, and a number of solutions have been described in the art for providing a flavourant at a location in a mouthpiece filter or dispersed within the tobacco cut filler.

However, given how the aerosol is generated and delivered to the consumer in aerosol-generating articles, ensuring a consistent flavour delivery during use may be difficult, and so a consumer may perceive fluctuations or a decrease in flavour intensity over time. Additionally, even prior to the aerosol-generating articles being used, some flavour species may be lost during certain production steps or during transportation and storage of the aerosol-generating articles.

It has previously been proposed to reduce the loss of volatile flavourants from smoking conventional filter cigarettes during storage through the encapsulation of the flavourant, for example in the form of a capsule or microcapsule containing a flavourant formulation. The encapsulated flavour species can be released prior to or during smoking of the filter cigarette by breaking open the encapsulating structure, for example by manually crushing the structure. However, the encapsulated flavourant is typically released from the encapsulating structure in a single burst, and so one such solution might fail to provide a consistently intense flavour delivery during use of the article.

Therefore, a need is felt to provide aerosol-generating articles containing flavour materials that are associated with an enhanced flavour perception for the consumer, particularly towards the end of the use cycle of the aerosol-generating article.

The present disclosure relates to an aerosol-generating article for generating an aerosol upon heating. The aerosol-generating article may comprise a flavour material.

The aerosol-generating article may comprise an aerosol-generating element comprising a rod of aerosol-generating substrate circumscribed by a wrapper. The flavour material may be provided in the wrapper circumscribing the rod of aerosol-generating substrate.

The aerosol-generating article may comprise a downstream section provided immediately downstream of the aerosol-generating element and extending from a downstream end of the aerosol-generating element to a downstream end of the aerosol-generating article.

The flavour material may be provided in the downstream section.

For example, the downstream section may comprise a hollow tubular element provided immediately downstream of the aerosol-generating element. An upstream end of the hollow tubular element may abut a downstream end of the aerosol-generating element. The flavour material may be provided in the hollow tubular element.

As an alternative, the downstream section may comprise a hollow tubular element provided downstream of the aerosol-generating element, and the flavour material may be provided between a downstream end of the aerosol-generating element and an upstream end of the hollow tubular element. For example, the flavour material may be sandwiched between the aerosol-generating element and the hollow tubular element.

The aerosol-generating article may comprise an upstream section provided immediately upstream of the aerosol-generating element and extending from an upstream end of the aerosol-generating element to an upstream end of the aerosol-generating article.

The flavour material may be provided in the upstream section.

For example, the upstream section may comprise an upstream element provided immediately upstream of the aerosol-generating element. A downstream end of the upstream element may abut an upstream end of the aerosol-generating element. The flavour material may be provided in the upstream element.

As an alternative, the upstream section may comprise an upstream element provided upstream of the aerosol-generating element, and the flavour material may be provided between an upstream end of the aerosol-generating element and a downstream end of the upstream element. For example, the flavour material may be sandwiched between the aerosol-generating element and the upstream element.

The flavour material may comprise a polysaccharide matrix structure comprising gellan gum and emulsifier; and a flavourant formulation dispersed within the polysaccharide matrix structure. The flavourant formulation may be at least partly trapped within the polysaccharide matrix structure and releasable from the polysaccharide matrix structure upon heating of the flavour material.

According to a first aspect of the present invention, there is provided an aerosol-generating article for generating an aerosol upon heating. The aerosol-generating article comprises an aerosol-generating element comprising a rod of aerosol-generating substrate circumscribed by a wrapper. Further, the aerosol-generating article comprises a downstream section provided immediately downstream of the aerosol-generating element and extending from a downstream end of the aerosol-generating element to a downstream end of the aerosol-generating article; and

an upstream section provided immediately upstream of the aerosol-generating element and extending from an upstream end of the aerosol-generating element to an upstream end of the aerosol-generating article. The aerosol-generating article comprises a flavour material provided in at least one of the downstream section, the upstream section, and the wrapper circumscribing the rod of aerosol-generating substrate. The flavour material comprises: a polysaccharide matrix structure comprising gellan gum and emulsifier; and a flavourant formulation dispersed within the polysaccharide matrix structure, wherein the flavourant formulation is at least partly trapped within the polysaccharide matrix structure and releasable from the polysaccharide matrix structure upon heating of the flavour material.

As used herein with reference to the invention, the term “aerosol-generating article” is used to describe an article comprising an aerosol-generating substrate that is heated to generate an inhalable aerosol for delivery to a user.

As used herein with reference to the invention, the term “aerosol-generating substrate” is used to describe a substrate comprising aerosol-generating material that is capable of releasing upon heating volatile compounds that can generate an aerosol.

As used herein with reference to the invention, the term “aerosol” is used to describe a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

As used herein with reference to the invention, the term “aerosol-generating device” is used to describe a device that interacts with the aerosol-generating substrate of the aerosol-generating article to generate an aerosol.

Aerosol-generating articles according to the invention have a proximal end through which, in use, an aerosol exits the aerosol-generating article for delivery to a user. The proximal end of the aerosol-generating article may also be referred to as the downstream end or mouth end of the aerosol-generating article. In use, a user draws directly or indirectly on the proximal end of the aerosol-generating article in order to inhale an aerosol generated by the aerosol-generating article.

Aerosol-generating articles according to the invention have a distal end. The distal end is opposite the proximal end. The distal end of the aerosol-generating article may also be referred to as the upstream end of the aerosol-generating article.

Components of aerosol-generating articles according to the invention may be described as being upstream or downstream of one another based on their relative positions between the proximal end of the aerosol-generating article and the distal end of the aerosol-generating article.

As used herein with reference to the invention, the term “longitudinal” is used to describe the direction between the upstream end and the downstream end of the aerosol-generating article. During use, air is drawn through the aerosol-generating article in the longitudinal direction.

As used herein with reference to the invention, the term “length” is used to describe the maximum dimension of the aerosol-generating article or a component of the aerosol-generating article in the longitudinal direction.

As used herein with reference to the invention, the term “transverse” is used to describe the direction perpendicular to the longitudinal direction. Unless otherwise stated, references to the “cross-section” of the aerosol-generating article or a component of the aerosol-generating article refer to the transverse cross-section.

As used herein with reference to the invention, the term “width” denotes the maximum dimension of the aerosol-generating article or a component of the aerosol-generating article in a transverse direction. Where the aerosol-generating article has a substantially circular cross-section, the width of the aerosol-generating article corresponds to the diameter of the aerosol-generating article. Where a component of the aerosol-generating article has a substantially circular cross-section, the width of the component of the aerosol-generating article corresponds to the diameter of the component of the aerosol-generating article.

As used herein with reference to the invention, the term “hollow tubular element” is used to denote a generally cylindrical element having a lumen along a longitudinal axis thereof. The tubular portion may have a substantially circular, oval or elliptical cross-section. The lumen may have a substantially circular, oval or elliptical cross-section. In particular, the term “hollow tubular element” is used to denote an element defining at least one airflow conduit establishing an uninterrupted fluid communication between an upstream end of the hollow tubular element and a downstream end of the tubular element.

In general, it has been recognised that use of a flavour material in an aerosol-generating article, wherein an aerosol-generating substrate is meant to be heated to generate the aerosol, presents different challenges and poses different constraints, compared with conditions encountered in the past with conventional cigarettes, wherein a substrate is combusted to generate a smoke. The inventors have found that the provision of a flavour material at selected locations outside of the rod of aerosol-generating substrate allow flavour species to be released and delivered to the consumer during use in controlled fashion, such that the flavour species may be combined with the aerosol species generated upon heating the aerosol-generating substrate. Because the flavour material is exposed to a heating profile different from the one the aerosol-generating substrate experiences during use—for example, due to the flavour material being farther away from or closer to a heat source compared with the aerosol-generating substrate—it may be possible to control the intensity and duration of the flavour release without this perturbing the mechanism by which the aerosol species are released.

By way of example, the inventors have found that aerosol-generating articles in accordance with the present invention may exhibit a generally more efficient puff-by-puff flavour release, in that the levels of flavour species released with each consecutive puff may be maintained substantially constant or even increase gradually during a use cycle of the article.

Additionally, because the flavourant formulation is at least partly trapped within the matrix structure until it is released upon heating, aerosol-generating articles in accordance with the present invention have been found to undergo significantly reduced losses of flavour species during storage, transportation, and so forth, even under stress conditions. This makes for a particularly efficient use of flavourants and other ingredients of the flavourant formulation.

Further, as will be discussed in more detail below, the inventors have found that by adjusting the relative proportions of the various ingredients in the formulation or by altering the composition of the matrix—for example, by selecting certain combinations of polysaccharides to form the matrix—or by doing both, it may advantageously be possible to finely tailor certain characteristics of the flavour material to specific needs associated with use in an aerosol-generating article. For example, the flavour release profile may be adjusted, such as to have the flavour released in more successive “waves” during use. As a result, the consumer may perceive flavour notes as more intense or lingering for longer during use. Thus, aerosol-generating articles in accordance with the present invention may offer a wider breadth of flavour profiles that were not accessible with existing aerosol-generating articles.

The inventors have also found that by incorporating certain compounds in the flavour material—for example, carbon particles or additives which undergo thermal decomposition and which generate gaseous compounds as the product of their thermal decomposition—it may be possible to enhance the release of flavour species from the flavour material around selected, relatively low temperatures. This is beneficial because such enhanced-release flavour materials may be provided at locations within the aerosol-generating article that are heated less intensely than the aerosol-generating substrate without this disparity in the heat supply being detrimental to the intensity and quality of flavour delivery experienced by the consumer.

In aerosol-generating articles in accordance with the present invention, the polysaccharide matrix structure preferably comprises gellan gum and an emulsifier.

The term “gellan gum” is used to identify a water-soluble anionic polysaccharide, which is produced by the bacterium Sphingomonas elodea. The repeating unit of the polymer is a tetrasaccharide, which consists of two residues of D-glucose and one of each residues of L-rhamnose and D-glucuronic acid. Gellan gum has been approved for food, non-food, cosmetic and pharmaceutical uses by authorities in many jurisdictions, such as Japan, USA, Canada, China, South Korea and the EU.

Two forms of gellan gum are known—namely, high acyl gellan gum and low acyl gellan gum—which differ by way of the degree/percent of substitution by O-acyl groups.

In flavour materials in accordance with the present invention, the gellan gum is preferably low acyl gellan gum. This is a gellan gum that is partly deacylated or fully deacylated. Its most common form is the fully deacylated one, with no detectable acyl groups, which is also called deacetylated gellan gum.

Use of low acyl gellan gum to form the polysaccharide matrix of a flavour material in accordance with the present invention is preferred because low acyl gellan gum is capable of forming gels at very low concentrations. Additionally, the texture of gellan gum based gels varies with the acyl content, low acyl gellan gum typically forming firmer, less elastic and more brittle gels compared with high acyl gellan gum.

In embodiments wherein the polysaccharide matrix structure comprises gellan gum and an emulsifier, a flavour material may advantageously be provided wherein a substantial fraction of the flavourant formulation is effectively trapped within the polysaccharide matrix structure. This is beneficial in that it improves the stability of the flavour material. Further, as it will be discussed in more detail below, it has an impact on how flavour species are released upon heating the flavour material, and so it may help tune a flavourant release profile during use.

Additionally, from a manufacturing viewpoint, a stable polysaccharide matrix structure comprising gellan gum and an emulsifier can be formed by supplying heat to the starting reagents without requiring the use of cross-linking agents. In fact, by kneading and emulsifying the flavourant formulation and gellan gum in a heated aqueous bath, the polysaccharide-coated flavourant can be brought to an emulsified state which is then substantially preserved after drying and cooling. Advantageously, this allows for a significant amount of flavourant to be provided in an immobilised state within the polysaccharide matrix, and so a flavour material with a high flavourant content may be provided.

Preferably, the emulsifier is lecithin. Use of lecithin as the emulsifier is advantageous in that it is commonly available and generally recognised as being non-toxic. Like gellan gum, lecithin is commonly used in the food industry as an additive, and has been approved for such use by both the USA Food and Drug Administration and the EU authorities. As such, the pairing of gellan gum and lecithin is especially adapted to be included in a flavour material destined for human use.

Preferably, where the polysaccharide matrix comprises gellan gum and an emulsifier, the gellan gum makes up from 5 percent by weight to 99.9 percent by weight of the flavour material on a dry weight basis.

More preferably, the gellan gum makes up at least 7 percent by weight of the flavour material on a dry weight basis, even more preferably at least 10 percent by weight of the flavour material on a dry weight basis.

The gellan gum preferably makes up for up to 80 percent by weight of the flavour material on a dry weight basis, more preferably up to 60 percent by weight of the flavour material on a dry weight basis, even more preferably up to 40 percent by weight of the flavour material on a dry weight basis, particularly preferably up to 30 percent by weight of the flavour material on a dry weight basis.

In some embodiments, the gellan gum makes up from 5 percent by weight to 80 percent by weight of the flavour material on a dry weight basis, preferably from 5 percent by weight to 60 percent by weight of the flavour material on a dry weight basis, more preferably from 5 percent by weight to 40 percent by weight of the flavour material on a dry weight basis, even more preferably from 5 percent by weight to 30 percent by weight of the flavour material on a dry weight basis.

In other embodiments, the gellan gum makes up from 10 percent by weight to 80 percent by weight of the flavour material on a dry weight basis, preferably from 10 percent by weight to 60 percent by weight of the flavour material on a dry weight basis, more preferably from 10 percent by weight to 40 percent by weight of the flavour material on a dry weight basis, even more preferably from 10 percent by weight to 30 percent by weight of the flavour material on a dry weight basis.

The emulsifier may make up from 0.01 percent by weight to 2 percent by weight of the flavour material on a dry weight basis. Preferably, the emulsifier makes up from 0.02 percent by weight to 2 percent by weight of the flavour material on a dry weight basis. More preferably, the emulsifier makes up from 0.05 percent by weight to 2 percent by weight of the flavour material on a dry weight basis. Even more preferably, the emulsifier makes up from 0.1 percent by weight to 2 percent by weight of the flavour material on a dry weight basis.

In preferred embodiments, emulsifier is lecithin and makes up from 0.01 percent by weight to 2 percent by weight of the flavour material on a dry weight basis. Preferably, lecithin makes up from 0.02 percent by weight to 2 percent by weight of the flavour material on a dry weight basis. More preferably, lecithin makes up from 0.05 percent by weight to 2 percent by weight of the flavour material on a dry weight basis. Even more preferably, lecithin makes up from 0.1 percent by weight to 2 percent by weight of the flavour material on a dry weight basis.

In certain embodiments, the polysaccharide matrix structure comprises gellan gum as the sole polysaccharide.

In other embodiments, the polysaccharide matrix structure comprises gellan gum in combination with at least a further polysaccharide selected from the group consisting of guar, tamarind gum, sodium alginate, xanthan gum, sodium carboxymethyl cellulose, and hydroxypropyl methyl cellulose.

Flavour materials according to the invention wherein the polysaccharide matrix structure comprises gellan gum in combination with one or more of the polysaccharides listed above have been found to provide different flavourant release profiles upon heating. For example, in embodiments wherein the polysaccharide matrix structure comprises gellan gum in combination with another one of the polysaccharides listed above, a flavourant release profile characterised by two distinct peaks at two different temperatures has been observed. Without wishing to be bound by theory, it is hypothesised that this is due to a different strength of interaction between the flavourant and each polysaccharide in the matrix structure, and may also have to do with each polysaccharide undergoing thermal decomposition at slightly different temperatures.

Because different combinations of polysaccharides in the matrix structure will generally lead to slightly different flavourant release profiles when the flavour material is heated, embodiments wherein gellan gum is combined with one or more of the other polysaccharides listed above may advantageously be used to fine-tune the flavourant release during use of an aerosol-generating article containing the flavour material. Additionally, different flavour materials, each containing a polysaccharide matrix structure comprising a different combination of polysaccharides, may be used in combination in a single aerosol-generating article to further adjust and control flavourant delivery during a whole use cycle of the aerosol-generating article. For example, incorporating in a single aerosol-generating article different flavour materials according to the invention, wherein the different flavour materials are adapted to release most of the flavourant at different temperature or at different times during the use cycle may help maintain an overall flavour delivery substantially consistent throughout.

In embodiments of the flavour material wherein the matrix structure comprises gellan gum in combination with at least one of the additional polysaccharides listed above, the at least one additional polysaccharide may make up at least 0.01 percent by weight of the flavourant delivery material on a dry weight basis. Preferably, the at least one additional polysaccharide makes up at least 0.1 percent by weight of the flavourant delivery material on a dry weight basis. More preferably, the at least one additional polysaccharide makes up at least 1.0 percent by weight of the flavourant delivery material on a dry weight basis. Even more preferably, the at least one additional polysaccharide makes up at least 2.0 percent by weight of the flavourant delivery material on a dry weight basis. In particularly preferred embodiments, the at least one additional polysaccharide makes up at least 5 percent by weight of the flavourant delivery material on a dry weight basis.

In embodiments of the flavour material wherein the matrix structure comprises gellan gum in combination with at least one of the additional polysaccharides listed above, the at least one additional polysaccharide may make up 80 percent by weight or less of the flavourant delivery material on a dry weight basis. Preferably, the at least one additional polysaccharide makes up 35 percent by weight or less of the flavourant delivery material on a dry weight basis. More preferably, the at least one additional polysaccharide makes up 25 percent by weight or less of the flavourant delivery material on a dry weight basis. Even more preferably, the at least one additional polysaccharide makes up 15 percent by weight or less of the flavourant delivery material on a dry weight basis.

In some embodiments, the at least one additional polysaccharide makes up from 1.0 percent to 35 percent by weight or less of the flavourant delivery material on a dry weight basis, preferably from 2.0 percent to 35 percent by weight or less of the flavourant delivery material on a dry weight basis, more preferably from 5.0 percent to 35 percent by weight or less of the flavourant delivery material on a dry weight basis.

In other embodiments, the at least one additional polysaccharide makes up from 1.0 percent to 25 percent by weight or less of the flavourant delivery material on a dry weight basis, preferably from 2.0 percent to 25 percent by weight or less of the flavourant delivery material on a dry weight basis, more preferably from 5.0 percent to 25 percent by weight or less of the flavourant delivery material on a dry weight basis.

In further embodiments, the at least one additional polysaccharide makes up from 1.0 percent to 15 percent by weight or less of the flavourant delivery material on a dry weight basis, preferably from 2.0 percent to 15 percent by weight or less of the flavourant delivery material on a dry weight basis, more preferably from 5.0 percent to 15 percent by weight or less of the flavourant delivery material on a dry weight basis.

The flavour material may comprise at least 0.01 percent by weight of a flavourant on a dry weight basis. Preferably, the flavour material comprises at least 1 percent by weight of a flavourant on a dry weight basis. More preferably, the flavour material comprises at least 5 percent by weight of a flavourant on a dry weight basis. Even more preferably, the flavour material comprises at least 10 percent by weight of a flavourant on a dry weight basis.

In certain embodiments, the flavour material comprises at least 20 percent by weight of a flavourant on a dry weight basis, preferably at least 25 percent by weight of a flavourant on a dry weight basis, more preferably at least 30 percent by weight of a flavourant on a dry weight basis.

The flavour material may up to 90 percent by weight of a flavourant on a dry weight basis. Preferably, the flavour material may up to 85 percent by weight of a flavourant on a dry weight basis. More preferably, the flavour material may up to 80 percent by weight of a flavourant on a dry weight basis. Even more preferably, the flavour material may up to 75 percent by weight of a flavourant on a dry weight basis.

In certain preferred embodiments, the flavour material comprises from 20 percent by weight to 80 percent by weight of a flavourant on a dry weight basis, preferably from 25 percent by weight to 80 percent by weight of a flavourant on a dry weight basis, more preferably from 30 percent by weight to 80 percent by weight of a flavourant on a dry weight basis.

In other preferred embodiments, the flavour material comprises from 20 percent by weight to 75 percent by weight of a flavourant on a dry weight basis, preferably from 25 percent by weight to 75 percent by weight of a flavourant on a dry weight basis, more preferably from 30 percent by weight to 75 percent by weight of a flavourant on a dry weight basis.

Suitable flavourants for inclusion in the flavourant formulation of a flavour material in accordance with the present invention include, but are not limited to, menthol, limonene, and eugenol.

Menthol is a monoterpenoid, which may be made synthetically or obtained from the oils of peppermint or other mints. It imparts minty, cool flavour notes.

Limonene is a cyclic monoterpene, and is typically found in the oil of citrus fruit peels. It is also a component of the aromatic resins of numerous coniferous and broadleaved trees. It imparts citrusy flavour notes.

Eugenol is an allyl chain-substituted guaiacol, and is commonly found in the essential oils of clove, nutmeg, cinnamon, basil and bay leaf. It imparts spicy, clove-like flavour notes.

The inventors have found that menthol and limonene can be fairly easily trapped and immobilised within the polysaccharide matrix, and so flavour materials containing a flavourant formulation containing menthol, limonene or mixtures thereof exhibit very good stability.

In preferred embodiments, the flavourant formulation comprises menthol.

The flavour material may comprise at least 0.01 percent by weight of a menthol on a dry weight basis. Preferably, the flavour material comprises at least 1 percent by weight of a menthol on a dry weight basis. More preferably, the flavour material comprises at least 5 percent by weight of a menthol on a dry weight basis. Even more preferably, the flavour material comprises at least 10 percent by weight of a menthol on a dry weight basis.

In certain embodiments, the flavour material comprises at least 20 percent by weight of a menthol on a dry weight basis, preferably at least 25 percent by weight of a menthol on a dry weight basis, more preferably at least 30 percent by weight of a menthol on a dry weight basis.

The flavour material may up to 90 percent by weight of a menthol on a dry weight basis. Preferably, the flavour material may up to 85 percent by weight of a menthol on a dry weight basis. More preferably, the flavour material may up to 80 percent by weight of a menthol on a dry weight basis. Even more preferably, the flavour material may up to 75 percent by weight of a menthol on a dry weight basis.

In certain preferred embodiments, the flavour material comprises from 20 percent by weight to 80 percent by weight of a menthol on a dry weight basis, preferably from 25 percent by weight to 80 percent by weight of a menthol on a dry weight basis, more preferably from 30 percent by weight to 80 percent by weight of a menthol on a dry weight basis.

In other preferred embodiments, the flavour material comprises from 20 percent by weight to 75 percent by weight of a menthol on a dry weight basis, preferably from 25 percent by weight to 75 percent by weight of a menthol on a dry weight basis, more preferably from 30 percent by weight to 75 percent by weight of a menthol on a dry weight basis.

The flavourant formulation typically comprises a solvent into which the flavourant is at least partly dissolved. Suitable solvents for inclusion in the flavourant formulation of flavour materials in accordance with the present invention include, but are not limited to, water and glycerol.

The inventors have found that solubility of a flavourant in a given solvent may have an impact on how stably the flavourant is retained within the flavour material during storage of an aerosol-generating article containing the flavour material. In more detail, the inventors have found that a greater affinity between the flavourant and the solvent favourably impact stability.

The Hansen solubility parameters provide a model for estimating the mutual affinity in any given flavourant/solvent pairing.

The solubility parameter δ—measured in MPa—is a function of parameters that are an indication of energy associated with dispersion forces between molecules (δ_{d}), intermolecular forces between molecules (δₚ), and hydrogen bonds between molecules (δₕ), as expressed by the following formula:

$${δ}^{2} = {( {δ}_{d} )}^{2} + {( {δ}_{p} )}^{2} + {( {δ}_{h} )}^{2}$$

Parameters, δ_{d}, δₚ, and δₕ may be regarded as coordinates for a point in a three-dimensional space (the Hansen space). The distance Rₐ between two molecules in the Hansen space provides an indication of the affinity between the two molecules, and is calculated based on the following formula:

$${( {R}_{a} )}^{2} = 4 {( {δ}_{d 2} - {δ}_{d 1} )}^{2} + {( {δ}_{p 2} - {δ}_{p 1} )}^{2} + {( {δ}_{h 2} - {δ}_{h 1} )}^{2}$$

In general, it is understood that lower values of Rₐ indicate a higher affinity in a given flavourant/solvent pairing.

With reference to flavourant formulations for inclusion in a flavour material in accordance with the present invention, the inventors have looked at pairing flavourants with glycerol as the solvent. In doing so, they have identified a number of flavourant/glycerol pairings that display particularly good stability of the flavourant within the flavour material during storage.

Preferably, flavourant/glycerol pairings for inclusion in the flavourant formulations of flavour materials in accordance with the present invention have a Rₐ for the flavourant/glycerol pairing is less than or equal to 22 MPa. The inventors have found that this condition is regarded as being indicative of a particularly high affinity between the flavourant and glycerol, and so flavourant/glycerol pairings with such an Rₐ consistently lead to flavour material having a particularly good flavour stability during storage. On this basis, the inventors have found that preferred flavourant/glycerol pairings for inclusion in the flavourant formulations of flavour materials in accordance with the present invention include: d-limonene/glycerol, I-menthone/glycerol, (E)-citral/glycerol, decanal/glycerol, linalool/glycerol. In some embodiments, the flavour material further comprises a polyol having the formula CₙH₂ₙ₊₂Oₙ.

The term “polyol” is used herein to describe an organic compound comprising two or more hydroxyl groups. Polyols containing two, three, and four hydroxyl groups may also be referred to as diols, triols, and tetrols, respectively.

Preferred polyols for inclusion in a flavour material in accordance with the present invention include glycerol, sorbitol, xylitol, mannitol, and erythritol.

The incorporation of a polyol in the flavour material has a beneficial effect on its pliability. This may make the flavour material easier to handle and given a predetermined form, which may facilitate its incorporation into an aerosol-generating article.

Preferably, in embodiments where the flavour material comprises a polyol as described above, the polyol makes up from 0.01 percent by weight to 20 percent by weight of the flavour material on a dry weight basis. More preferably, the polyol makes up from 0.01 percent by weight to 15 percent by weight of the flavour material on a dry weight basis. Even more preferably, the polyol makes up from 0.01 percent by weight to 10 percent by weight of the flavour material on a dry weight basis.

In some embodiments, the flavour material comprises fibres, preferably cellulose fibres.

The inventors have found that the inclusion of fibres may increase the structural strength of the flavour material, which is especially beneficial in those embodiments wherein the polysaccharide matrix trapping the flavourant formulation is not supported by a carrier sheet material.

In embodiments of the flavour material comprising cellulose fibres, the cellulose fibres may make up at least 0.01 percent by weight of the flavour material on a dry weight basis.

The incorporation of fibres, especially cellulose fibres, may advantageously improve the tensile strength of the flavour material, particularly when it is provided in sheet form. This facilitates the manufacturing process, both of the flavour material itself and of an aerosol-generating article including the flavour material.

Preferably, the cellulose fibres make up at least 0.05 percent by weight of the flavour material on a dry weight basis. More preferably, the cellulose fibres make up at least 0.5 percent by weight of the flavour material on a dry weight basis. Even more preferably, the cellulose fibres make up at least 1.0 percent by weight of the flavour material on a dry weight basis. In particularly preferred embodiments, the cellulose fibres make up at least 2.0 percent by weight of the flavour material on a dry weight basis.

The cellulose fibres may make up 10 percent by weight or less of the flavour material on a dry weight basis. Preferably, the cellulose fibres make up 8.0 percent by weight or less of the flavour material on a dry weight basis. More preferably, the cellulose fibres make up 7.0 percent by weight or less of the flavour material on a dry weight basis. Even more preferably, the cellulose fibres make up 5.0 percent by weight or less of the flavour material on a dry weight basis.

In some embodiments, the fibres make up from 0.01 percent by weight to 10 percent by weight of the flavour material on a dry weight basis. Preferably, the fibres make up from 0.01 percent by weight to 8.0 percent by weight of the flavour material on a dry weight basis. More preferably, the fibres make up from 0.01 percent by weight to 7.0 percent by weight of the flavour material on a dry weight basis. Even more preferably, the fibres make up from 0.01 percent by weight to 5 percent by weight of the flavour material on a dry weight basis.

In other embodiments, the fibres make up from 1.0 percent by weight to 10 percent by weight of the flavour material on a dry weight basis. Preferably, the fibres make up from 1.0 percent by weight to 8.0 percent by weight of the flavour material on a dry weight basis. More preferably, the fibres make up from 1.0 percent by weight to 7.0 percent by weight of the flavour material on a dry weight basis. Even more preferably, the fibres make up from 1.0 percent by weight to 5 percent by weight of the flavour material on a dry weight basis.

In further embodiments, the fibres make up from 2.0 percent by weight to 10 percent by weight of the flavour material on a dry weight basis. Preferably, the fibres make up from 2.0 percent by weight to 8.0 percent by weight of the flavour material on a dry weight basis. More preferably, the fibres make up from 2.0 percent by weight to 7.0 percent by weight of the flavour material on a dry weight basis. Even more preferably, the fibres make up from 2.0 percent by weight to 5 percent by weight of the flavour material on a dry weight basis.

In some embodiments, a flavour material in accordance with the present invention may comprise a salt of calcium or a salt of magnesium or both, such as calcium chloride or calcium lactate.

In embodiments where the flavour material comprises a salt of calcium or a salt of magnesium or both, the salt or salts make up from 0.01 percent by weight to 10 percent by weight on a dry weight basis. Preferably, the salt or salts make up from 0.01 percent by weight to 5 percent by weight on a dry weight basis.

A flavour material in accordance with the present invention may generally comprise water. This is because the flavour material will generally be manufactured by combining the various compounds described above in an aqueous bath. After drying, the water content will be reduced, but may generally be non-null.

Thus, a flavour material in accordance with the present invention may comprise from 0.01 percent by weight to 10 percent by weight of water, preferably from 0.01 percent by weight to 8 percent by weight of water, more preferably from 0.01 percent by weight to 6 percent by weight of water, even more preferably from 0.01 percent by weight to 4 percent by weight of water.

In some embodiments, the flavour material comprises from 0.5 percent by weight to 10 percent by weight of water, preferably from 0.01 percent by weight to 8 percent by weight of water, more preferably from 0.5 percent by weight to 6 percent by weight of water, even more preferably from 0.5 percent by weight to 4 percent by weight of water.

In other embodiments, the flavour material comprises from 1.0 percent by weight to 10 percent by weight of water, preferably from 1.0 percent by weight to 8 percent by weight of water, more preferably from 1.0 percent by weight to 6 percent by weight of water, even more preferably from 1.0 percent by weight to 4 percent by weight of water.

In further embodiments, the flavour material comprises from 1.5 percent by weight to 10 percent by weight of water, preferably from 1.5 percent by weight to 8 percent by weight of water, more preferably from 1.5 percent by weight to 6 percent by weight of water, even more preferably from 1.5 percent by weight to 4 percent by weight of water.

In certain embodiments, the flavour material further comprises a carrier material. The polysaccharide matrix structure and the flavourant formulation trapped therein are supported by the carrier material.

In some embodiments, the carrier material is a carrier sheet material. As used herein, the term “sheet material” denotes a laminar material having a width and length substantially greater than the thickness thereof. For example, the carrier material may be a sheet of homogenised tobacco material or a sheet of a paper material.

The inclusion of a carrier sheet material in flavour materials for use in aerosol-generating articles in accordance with the present invention has been found to enhance the structural strength of the flavour materials by virtue of the carrier sheet material supporting and holding in place the polysaccharide matrix trapping the flavourant formulation. By selecting and adjusting certain properties of the carrier sheet material (for example, its thickness) one may obtain a flavour material that is especially resistant to wear and tear and that has particularly good mechanical properties.

Compared with flavour materials having a comparable composition and matrix structure, but lacking the support of the carrier sheet material, flavour materials comprising a carrier material have been found to be easier to handle and may more conveniently stored, for example, in bobbin form. This advantageously facilitates their incorporation into an aerosol-generating article, particularly within the framework of a high-speed automated manufacturing process.

Flavour materials comprising a carrier material also have the advantage that the polysaccharide matrix structure and the flavourant formulation trapped therein may be deposited onto the carrier material—particularly, a carrier sheet material—to form a flavour material that is, in effect, in sheet form and that can, as such, be cut into pieces having a predetermined average size (for example, a predetermined cut width or a predetermined cut length or both). This makes it easy to incorporate the flavour material at predetermined locations within the aerosol-generating article, as will be described in more detail below.

For example, the polysaccharide matrix structure trapping the flavourant formulation may be formed in situ on a carrier sheet material. If this in situ formation step follows a manufacturing process from which the carrier sheet material may is obtained, the in situformation step may even be performed at a later date or at a different location.

As mentioned previously, in some preferred embodiments, the carrier sheet material may be in the form of a sheet of a homogenised tobacco material.

As used in the present specification, the term “homogenised tobacco material” encompasses any tobacco material formed by the agglomeration of particles of tobacco material. Sheets or webs of homogenised tobacco material are formed by agglomerating particulate tobacco obtained by grinding or otherwise powdering of one or both of tobacco leaf lamina and tobacco leaf stems. In addition, homogenised tobacco material may comprise a minor quantity of one or more of tobacco dust, tobacco fines, and other particulate tobacco by-products formed during the treating, handling and shipping of tobacco. The sheets of homogenised tobacco material may be produced by casting, extrusion, paper making processes or other any other suitable processes known in the art.

Sheets or webs of homogenised tobacco material for use in the invention may have a tobacco content of at least about 40 percent by weight on a dry weight basis, more preferably of at least about 60 percent by weight on a dry weight basis, more preferably or at least about 70 percent by weight on a dry basis and most preferably at least about 90 percent by weight on a dry weight basis.

Sheets or webs of homogenised tobacco material for use as the carrier sheet material may comprise one or more intrinsic binders, that is tobacco endogenous binders, one or more extrinsic binders, that is tobacco exogenous binders, or a combination thereof to help agglomerate the particulate tobacco. Alternatively, or in addition, sheets of homogenised tobacco material for use as the carrier sheet material may comprise other additives including, but not limited to, tobacco and non-tobacco fibres, aerosol-formers, humectants, plasticisers, flavourants, fillers, aqueous and non-aqueous solvents and combinations thereof.

Suitable extrinsic binders for inclusion in sheets or webs of homogenised tobacco material for use as the carrier sheet material are known in the art and include, but are not limited to: gums such as, for example, guar gum, xanthan gum, arabic gum and locust bean gum; cellulosic binders such as, for example, hydroxypropyl cellulose, carboxymethyl cellulose, hydroxyethyl cellulose, methyl cellulose and ethyl cellulose; polysaccharides such as, for example, starches, organic acids, such as alginic acid, conjugate base salts of organic acids, such as sodium-alginate, agar and pectins; and combinations thereof.

Suitable non-tobacco fibres for inclusion in sheets or webs of homogenised tobacco material for use as the carrier sheet material are known in the art and include, but are not limited to: cellulose fibres; soft-wood fibres; hard-wood fibres; jute fibres and combinations thereof. Prior to inclusion in sheets of homogenised tobacco material for use as the carrier sheet material, non-tobacco fibres may be treated by suitable processes known in the art including, but not limited to: mechanical pulping; refining; chemical pulping; bleaching; sulphate pulping; and combinations thereof.

Preferably, the sheets or webs of homogenised tobacco material comprise an aerosol former. As used herein, the term “aerosol former” describes any suitable known compound or mixture of compounds that, in use, facilitates formation of an aerosol and that is substantially resistant to thermal degradation at the operating temperature of the aerosol-generating article.

Suitable aerosol-formers are known in the art and include, but are not limited to: polyhydric alcohols, such as propylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate.

Preferred aerosol formers are polyhydric alcohols or mixtures thereof, such as propylene glycol, triethylene glycol, 1,3-butanediol and, most preferred, glycerine.

The sheets or webs of homogenised tobacco material may comprise a single aerosol former. Alternatively, the sheets or webs of homogenised tobacco material may comprise a combination of two or more aerosol formers.

The sheets or webs of homogenised tobacco material have an aerosol former content of greater than 10 percent on a dry weight basis. Preferably, the sheets or webs of homogenised tobacco material have an aerosol former content of greater than 12 percent on a dry weight basis. More preferably, the sheets or webs of homogenised tobacco material have an aerosol former content of greater than 14 percent on a dry weight basis. Even more preferably the sheets or webs of homogenised tobacco material have an aerosol former content of greater than 16 percent on a dry weight basis.

The sheets of homogenised tobacco material may have an aerosol former content of between approximately 10 percent and approximately 30 percent on a dry weight basis. Preferably, the sheets or webs of homogenised tobacco material have an aerosol former content of less than 25 percent on a dry weight basis.

In a preferred embodiment, the sheets of homogenised tobacco material have an aerosol former content of approximately 20 percent on a dry weight basis.

Sheets or webs of homogenised tobacco for use as the carrier sheet material in the flavour material of the present invention may be made by methods known in the art, for example the methods disclosed in International patent application WO-A-2012/164009 A2. In a preferred embodiment, sheets of homogenised tobacco material for use as the carrier sheet material are formed from a slurry comprising particulate tobacco, guar gum, cellulose fibres and glycerine by a casting process.

In other embodiments, the carrier sheet material may be in the form of a sheet of a non-tobacco aerosol-generating material. For example, the carrier sheet material may be a sheet of sorbent non-tobacco material loaded with nicotine (for example, in the form of a nicotine salt) and an aerosol-former. Examples of such rods are described in the international application WO-A-2015/082652. In addition, or as an alternative, the carrier sheet material may be a sheet of a homogenised non-tobacco plant material, such as an aromatic non-tobacco plant material.

In certain embodiments, the carrier sheet material may be in the form of a paper wrapper material. This has the benefit that the flavour material may be used as an alternative or in addition to conventional paper wrapper materials in the manufacture of an aerosol-generating article. Thus, the flavour material may be incorporated into the aerosol-generating article without significantly altering existing manufacturing processes and without requiring significant modifications of existing manufacturing apparatus.

In particular, in some embodiments, a flavour material comprising a paper wrapper material as the carrier material may circumscribe the rod of aerosol-generating substrate. Thus, the flavour material is immediately outside of the rod of aerosol-generating substrate and held at a predetermined, controlled location at the periphery of the aerosol-generating element instead of being dispersed within the aerosol-generating substrate.

In some embodiments, the flavour material comprises greater than 0.1 weight percent carbon particles, wherein the carbon particles have a volume mean particle size of greater than 10 micrometres.

The inclusion of carbon based material—such as graphite, expanded graphite, graphene, etc.—in the flavour materials of aerosol-generating articles in accordance with the present invention has been found to enhance flavour release, particularly at lower temperatures, with respect to flavour materials having comparable composition and structure, but lacking the carbon based material. Without wishing to be bound by theory, this is hypothesised to relate to an enhancement of the thermal conductivity of the flavour material, which may cause the flavourant formulation to be more promptly released from the polysaccharide matrix structure as a certain threshold temperature may be reached more quickly.

The improvement in flavour release is thought to be linked to a more even temperature distribution throughout the flavour material during use. With a greater proportion of the flavour material reaching a sufficiently high temperature to release flavour species from the matrix structure, a higher usage efficiency of the flavourant formulation is made possible.

The improved release of flavour species afforded by flavour material including carbon particles as set out above may also allow a heater configured to supply heat to an aerosol-generating article incorporating the flavour delivery material to operate at a lower temperature and thus require less power.

By adjusting the amount and size of the carbon particles, it may be possible to control and fine-tune the flavour release enhancement. For example, a relatively narrow particle size distribution may provide a flavour delivery material that is more homogenous in terms of thermal conductivity. This may mean that, during use, temperature gradients in the flavour material provided in different portions of an aerosol-generating article that are exposed to the same heating profile are minimised.

Preferably, the carbon particles consist of one or more of: graphite particles, expanded graphite particles and graphene particles. In a preferred embodiment, the carbon particles consist of one or both of expanded graphite particles and graphene particles.

Advantageously, particles such as those listed above, particularly graphite and expanded graphite, may have a high thermal conductivity and a low density, and so they may be able to substantially improve the thermal conductivity of the flavour material without significantly increasing the density of the flavour material. This may be advantageous in that an increase in density may increase the weight, and therefore the transport costs, for a given volume of the flavour material itself. Equally, an increase in density may potentially have a proportional impact on transport costs when the flavour material is incorporated into an aerosol-generating article.

Additionally, particles such as those listed above have the benefit that they may be inductively heated, and so heat may be supplied directly within a flavour material in accordance with the present invention when the flavour material is exposed to an electromagnetic field generated by an induction coil.

Preferably, the carbon particles have a volume mean particle size from 30 micrometres to 150 micrometres.

As used herein, the term “volume mean particle size” may refer to a mean calculated using the equation below, where d[4,3] is the volume mean particle size and d is the particle size.

$$d [ 4 , 3 ] = \frac{\sum {d}^{4}}{\sum {d}^{3}}$$

In other words, the volume mean particle size may refer to a mean calculated by dividing the sum of the particle sizes to the fourth power by the sum of the particle sizes to the third power.

Surprisingly, the inventors have found these relatively small particle size ranges to be particularly effective at increasing the thermal conductivity of a flavour material, particularly when the flavour material is in the form of or comprises a sheet. In addition, these relatively small particle sizes may advantageously result in a more homogeneous distribution of thermal conductivity, and in a sheet having a more even thickness than if larger particle sizes were used.

In embodiments wherein the flavour material comprises a carrier sheet material supporting the polysaccharide structure trapping the flavourant formulation, the carbon particles may be comprised within the carrier sheet material. This may be advantageous in that carbon particles in this size range may easily be mixed with the similarly sized particles used to manufacture the carrier sheet material, such as in the case of a sheet of homogenised tobacco material or other plant material.

The carbon particles may have a particle size distribution having a D10 particle size, a D50 particle size, and a D90 particle size. In such a particle size distribution, 10% of the particles have a particle size which is less than or equal to the D10 particle size and 90% of the particles have a particle size which is less than or equal to the D90 particle size. The D50 particle size is the median particle size so 50% of the particles have a particle size which is less than or equal to the D50 particle size.

The D90 particle size may be less than or equal to 50, 40, 30, 25, 20, 15, 10, 8, 5, or 3 times the D10 particle size. The D90 particle size may be greater than or equal to 2, 3, 5 or 8 times the D10 particle size.

The D90 particle size may be between 3 and 50, 3 and 40, 3 and 30, 3 and 25, 3 and 20, 3 and 15, 3 and 10, 3 and 8, 3 and 5, 5 and 50, 5 and 40, 5 and 30, 5 and 25, 5 and 20, 5 and 15, 5 and 10, 5 and 8, 8 and 50, 8 and 40, 8 and 30, 8 and 25, 8 and 20, 8 and 15, 8 and 10, 10 and 50, 10 and 40, 10 and 30, 10 and 25, 10 and 20, 10 and 15, 15 and 50, 15 and 40, 15 and 30, 15 and 25, 15 and 20 times the D10 particle size.

Preferred particle size distributions may have a D90 particle size between 3 and 25, or 3 and 15, times the D10 particle size. Particularly preferred particle size distributions may have a D90 particle size between 5 and 20, or 5 and 10, times the D10 particle size.

In certain preferred embodiments, in a flavour material according to the present invention the carbon particles have a particle size distribution with a D90 particle size and a D10 particles size, and the D90 particle size is no more than 25 or 15 times the D10 particle size.

A compromise must be made in relation to the particle size distribution. A tighter particle size distribution may advantageously provide a more uniform thermal conductivity throughout the flavour material. This is because there will be less variation in particle size in different locations in the flavour material. This may advantageously allow for more efficient usage of the flavourant formulation throughout the flavour material. However, a tighter particle size distribution may disadvantageously be more difficult and expensive to achieve. The inventors have found that the particle size distributions described above may provide an optimal compromise between these two factors.

Desired D10 and D90 particle sizes may be obtained by sieving. Sieving may therefore be used to obtain a narrow particle size distribution where desired.

The D10 particle size of the carbon particles may be greater than or equal to 1, 2, 3, 5, 10, 20, 30, 35, 50, 75, 100, 150, 200, 250, 500, or 900 microns. Each of the carbon particles may have a particle size of greater than or equal to 1, 2, 3, 5, 10, 20, 30, 35, 50, 75, 100, 150, 200, 250, 500, or 900 microns.

The D10 particle size of the carbon particles may be less than or equal to 1000, 900, 500, 200, 100, 150, 100, 75, 50, 35, 30, 20, 10, 5, 3 or 2 microns. Each of the carbon particles may have a particle size of less than or equal to 1000, 900, 500, 200, 100, 150, 100, 75, 50, 35, 30, 20, 10, 5, 3 or 2 microns.

The D90 particle size of the carbon particles may be less than or equal to 1000, 900, 500, 200, 100, 150, 100, 75, 50, 35, 30, 20, 10, 5, 3 or 2 microns. Each of the carbon particles may have a particle size of less than or equal to 1000, 900, 500, 200, 100, 150, 100, 75, 50, 35, 30, 20, 10, 5, 3 or 2 microns.

The D90 particle size of the carbon particles may be greater than or equal to 1, 2, 3, 5, 10, 20, 30, 35, 50, 75, 100, 150, 200, 250, 500, or 900 microns. Each of the carbon particles may have a particle size of greater than or equal to 1, 2, 3, 5, 10, 20, 30, 35, 50, 75, 100, 150, 200, 250, 500, or 900 microns.

One or both of a D50 particle size and a volume mean particle size of the carbon particles may be greater than or equal to 1, 2, 3, 5, 10, 20, 30, 35, 50, 75, 100, 150, 200, 250, 500, or 900 microns.

One or both of a D50 particle size and a volume mean particle size of the carbon particles may be less than or equal to 1000, 900, 500, 200, 100, 150, 100, 75, 50, 35, 30, 20, 10, 5, 3 or 2 microns.

One or both of a D50 particle size and a volume mean particle size of the carbon particles may be between 1 and 1000, preferably between 10 and 200, more preferably between 30 and 150, or even more preferably between 50 and 75 microns. Alternatively, or in addition, each of the carbon particles may have a particle size of between 1 and 1000, preferably between 10 and 200, more preferably between 30 and 150, or even more preferably between 50 and 75 microns.

Surprisingly, the inventors have found these relatively small particle size ranges to be particularly effective at increasing the thermal conductivity of a flavour material for use in aerosol-generating articles in accordance with the present invention, particularly in view of conditions of use wherein the flavour material is exposed to relatively low temperatures during use.

The carbon particles may have a volume mean particle size of greater than or equal to 1, 2, 3, 5, 10, 20, 30, 35, 50, 75, 100, 150, 200, 250, 500, or 900 microns.

It may be particularly preferable that the volume mean particle size of the carbon particles is greater than 10 microns.

The carbon particles may have a volume mean particle size of less than or equal to 1000, 900, 500, 200, 100, 150, 100, 75, 50, 35, 30, 20, 10, 5, 3 or 2 microns.

The carbon particles may have a volume mean particle size of between 1 and 1000, 10 and 200, 30 and 150, or 50 and 75 microns. These volume mean particle size ranges may be particularly preferable where the flavour material comprises, or is in the form of, a sheet.

The carbon particles may have a volume mean particle size at least 2, 3, 5, 8, 10, 15, or 20 times the number mean particle size.

It may be particularly preferable that the thermally conductive particles are, or comprise, graphite particles.

The graphite particles may have a particle size distribution with a D10 particle size of between 5 and 20, for example 10 and 14, microns, for example around 12 microns. The graphite particles may have a particle size distribution with a D50 particle size of between 25 and 45 microns, for example around 35 microns. The graphite particles may have a particle size distribution with a D90 particle size of between 45 and 75 microns, for example around 55 microns. Advantageously, such particles are commercially available and have been found by the inventors to provide a significant increase in the thermal conductivity of flavour materials.

It may be particularly preferable that the thermally conductive particles are, or comprise, expanded graphite particles.

The expanded graphite particles may have a particle size distribution with a D10 particle size of between 5 and 20, for example 9 and 12, microns, for example around 10.5 microns. The expanded graphite particles may have a particle size distribution with a D50 particle size of between 15 and 25 microns, for example around 20 microns. The expanded graphite particles may have a particle size distribution with a D90 particle size of between 46 and 66 microns, for example around 56 microns. Advantageously, such particles are commercially available and have been found by the inventors to provide a significant increase in the thermal conductivity of flavour materials. The expanded graphite particles may also advantageously reduce the overall density of the flavour material.

Each of the carbon particles may have three mutually perpendicular dimensions. A largest dimension of these three dimensions may be no more than 10, 8, 5, 3, or 2 times larger than a smallest dimension of these three dimensions. A largest dimension of these three dimensions being no more than 10, 8, 5, 3, or 2 times larger than a second largest dimension of these three dimensions. Each of these three dimensions may be substantially equal. Each of the carbon particles may be substantially spherical.

The carbon particles may comprise at least 10, 20, 50, 100, 200, 500, or 1000 particles.

In a flavour material in accordance with the present invention, the carbon particles make up from 0.01 percent by weight to 10 percent by weight of the flavour material on a dry weight basis.

In some embodiments, the flavour material comprises greater than 0.1 weight percent of an additive selected from the group consisting of polycarboxylic acids, salts containing a hydrogencarbonate functional group, and mixtures thereof.

The inclusion of an additive selected from the group described above in flavour materials for use in aerosol-generating articles in accordance with the present invention has been found to have an impact on flavour release profile, in particular by facilitating and enhancing release of flavour at lower temperatures compared with flavour materials having substantially the same composition and structure, but containing no such additive.

Without wishing to be bound by theory, this effect is understood to be linked to the gaseous compounds released upon thermal decomposition of the additive. These gaseous compounds are thought to disrupt the polysaccharide matrix structure, presumably by breaking open some of the internal pockets within which the flavourant formulation is immobilised.

Thus, the improved release of flavour species afforded by flavour materials comprising one or more of additives set out above may also allow a heater configured to supply heat to an aerosol-generating article incorporating the flavour material to operate at a lower temperature and thus require less power during use.

By adjusting the content of additive or by selecting specific additives or both, it may advantageously be possible to further control the flavour release profile. In fact, including a larger amount of additive in the flavour material has been found to generally cause a more significant shift of the flavourant release profile towards lower temperatures. Additionally, using different additives that undergo thermal decomposition at different temperatures, alone or in combination, may advantageously provide a tool for even more finely tuning the flavour release profile of the aerosol-generating article containing the flavour material.

Preferably, the additive decomposes thermally at a pressure of 1 bar at a temperature of less than 220 degrees Celsius. More preferably, the additive decomposes thermally at a pressure of 1 bar at a temperature of less than 200 degrees Celsius. Even more preferably, the additive decomposes thermally at a pressure of 1 bar at a temperature of less than 180 degrees Celsius.

The additive may decompose thermally at a pressure of 1 bar at a temperature of at least 100 degrees Celsius, preferably at least 120 degrees Celsius, more preferably at least 140 degrees Celsius.

In some embodiments, the additive decomposes thermally at a pressure of 1 bar at a temperature from 100 degrees Celsius to 220 degrees Celsius, preferably from 120 degrees Celsius to 220 degrees Celsius, more preferably from 140 degrees Celsius to 220 degrees Celsius.

In other embodiments, the additive decomposes thermally at a pressure of 1 bar at a temperature from 100 degrees Celsius to 200 degrees Celsius, preferably from 120 degrees Celsius to 200 degrees Celsius, more preferably from 140 degrees Celsius to 200 degrees Celsius.

In further embodiments, the additive decomposes thermally at a pressure of 1 bar at a temperature from 100 degrees Celsius to 180 degrees Celsius, preferably from 120 degrees Celsius to 180 degrees Celsius, more preferably from 140 degrees Celsius to 180 degrees Celsius.

Use of one or more selected additives that decompose thermally at a pressure of 1 bar at temperatures in the ranges described above has been identified as especially beneficial because, upon heating a flavour material in accordance with the present invention, these additives begin to decompose thermally at temperatures that are significantly lower than the temperature at which the polysaccharide or polysaccharides forming the matrix decompose thermally. As a result, gaseous products generated upon thermal decomposition of the additive or additives get to interact with the matrix structure and may disrupt its integrity, such as by progressively breaking open a pocket or pockets of the matrix structure within which the flavourant formulation is trapped, and they may do so before the integrity of the matrix structure may be affected by the supply of heat alone.

Polycarboxylic acids suitable for use as an additive in flavour materials in accordance with the present invention include, but are not limited to, tartronic acid, malonic acid, citric acid.

Salts containing a hydrogencarbonate functional group suitable for use as an additive in flavour materials in accordance with the present invention include, but are not limited to, sodium hydrogencarbonate, potassium hydrogencarbonate, magnesium hydrogencarbonate, calcium hydrogencarbonate, ammonium hydrogencarbonate.

Preferably, the additive makes up for less than or equal to 25 percent by weight of the flavour material on a dry weight basis. More preferably, the additive makes up for less than or equal to 20 percent by weight of the flavour material on a dry weight basis. Even more preferably, the additive makes up for less than or equal to 15 percent by weight of the flavour material on a dry weight basis. In particularly preferred embodiments, the additive makes up for less than or equal to 10 percent by weight of the flavour material on a dry weight basis.

Preferably, the additive makes up for at least 0.25 percent by weight of the flavour material on a dry weight basis. More preferably, the additive makes up for at least 0.5 percent by weight of the flavour material on a dry weight basis. Even more preferably, the additive makes up for at least 1.0 percent by weight of the flavour material on a dry weight basis.

Flavour materials for use in aerosol-generating articles in accordance with the present invention can be prepared by different routes.

A method of manufacturing one such flavour material may comprise a first step of preparing an aqueous composition comprising a flavourant formulation, a polysaccharide and an emulsifier; a second step of casting the aqueous composition over a substantially flat support surface; a third step of letting the aqueous composition jellify on the support surface; a fourth step of drying the jellified aqueous composition. The dried flavour material may subsequently be removed from the support surface. The support surface may be a metallic plate.

Another method of manufacturing one such flavour delivery in accordance with the present invention may comprise a first step of preparing an aqueous composition comprising a flavourant formulation, a polysaccharide and an emulsifier; a second step of casting the aqueous composition over a carrier sheet material lying on a substantially flat support surface; a third step of letting the aqueous composition jellify on the carrier sheet material; a fourth step of drying the jellified aqueous composition and the carrier sheet material. The dried flavour material wherein the carrier sheet material supports a polysaccharide matrix trapping the flavourant formulation may subsequently be removed from the support surface.

A further method of manufacturing one such flavour delivery in accordance with the present invention may comprise a first step of preparing an aqueous composition comprising a flavourant formulation, a polysaccharide and an emulsifier; a second step of spraying the aqueous composition over a carrier sheet material (for example, homogenised tobacco material) lying on a substantially flat support surface; a third step of letting the aqueous composition jellify on the carrier sheet material; a fourth step of drying the jellified aqueous composition and the carrier sheet material. The dried flavour material wherein the carrier sheet material supports a polysaccharide matrix trapping the flavourant formulation may subsequently be removed from the support surface.

As will be apparent from the foregoing description of flavour materials for incorporation in aerosol-generating articles in accordance with the present invention, the present invention provides a new range of aerosol-generating articles capable of delivering flavour to a consumer in a more consistent and controlled manner. Additionally, because the flavourant formulation is at least partly trapped within the matrix until it is released when heat is supplied to the aerosol-generating article during use, losses of flavour species during storage and transportation of the aerosol-generating articles can be greatly reduced. Coupled with the enhancement in flavour release obtainable, especially at lower temperatures, for certain embodiments this makes for a particularly efficient use of flavourants.

As described briefly above, an aerosol-generating article in accordance with the present invention comprises, in sequential arrangement, an upstream section; an aerosol-generating element; and a downstream section. The aerosol-generating element comprises a rod of aerosol-generating substrate circumscribed by a wrapper. A flavour material of the type described at length above is provided in at least one of: the wrapper circumscribing the rod of aerosol-generating substrate, the upstream section, and the downstream section.

In other words, the flavour material is provided at a location within the aerosol-generating article other than within the rod of aerosol-generating substrate.

The downstream section is provided immediately downstream of the aerosol-generating element and extends from a downstream end of the aerosol-generating element to a downstream end of the aerosol-generating article. The upstream section is provided immediately upstream of the aerosol-generating element and extending from an upstream end of the aerosol-generating element to an upstream end of the aerosol-generating article.

In some embodiments, the downstream section comprises a hollow tubular element provided immediately downstream of the aerosol-generating element. An upstream end of the hollow tubular element abuts a downstream end of the aerosol-generating element, and the flavour material is provided in the hollow tubular element.

In other embodiments, the downstream section comprises a hollow tubular element provided downstream of the aerosol-generating element, and the flavour material is provided between a downstream end of the aerosol-generating element and an upstream end of the hollow tubular element. For example, the flavour material is sandwiched between the aerosol-generating element and the hollow tubular element.

In some embodiments, the upstream section comprises an upstream element provided immediately upstream of the aerosol-generating element. A downstream end of the upstream element abuts an upstream end of the aerosol-generating element, and the flavour material is provided in the upstream element.

In other embodiments, the upstream section comprises an upstream element provided upstream of the aerosol-generating element, and the flavour material is provided between an upstream end of the aerosol-generating element and a downstream end of the upstream element.

For example, the flavour material is sandwiched between the aerosol-generating element and the upstream element.

The downstream section may further include one or more components downstream of the hollow tubular element. For example, the aerosol-generating article may include a mouthpiece element extending all the way to and defining a proximal end of the aerosol-generating article. The aerosol-generating article may additionally include an aerosol-cooling element provided between the hollow tubular element and the mouthpiece element. The hollow tubular element and the one or more additional components provided downstream of the hollow tubular element form a downstream section of the aerosol-generating article.

The upstream element may have a length of at least about 2 millimetres, at least about 3 millimetres, or at least about 4 millimetres.

The upstream element may have a length of less than or equal to about 10 millimetres, less than or equal to about 8 millimetres, or less than or equal to about 6 millimetres.

The upstream element may have a length of between about 2 millimetres and about 10 millimetres, between about 2 millimetres and about 8 millimetres, or between about 2 millimetres and about 6 millimetres.

The upstream element may have a length of between about 3 millimetres and about 10 millimetres, between about 3 millimetres and about 8 millimetres, or between about 3 millimetres and about 6 millimetres.

The upstream element may have a length of between about 4 millimetres and about 10 millimetres, between about 4 millimetres and about 8 millimetres, or between about 4 millimetres and about 6 millimetres.

For example, the upstream element may have a length of about 5 millimetres.

The length of the upstream element may be selected based on a desired balance between the ability of the upstream element to prevent or restrict upstream movement of aerosol-generating material from the aerosol-generating element and the RTD (resistance to draw) of the upstream element.

The length of the upstream element may be selected based on a desired total length of the aerosol-generating article.

The ratio of the length of the upstream element to the total length of the aerosol-generating article may be at least about 0.03, at least about 0.05, or at least about 0.07.

The ratio of the length of the upstream element to the total length of the aerosol-generating article may be less than or equal to about 0.25, less than or equal to about 0.2, or less than or equal to about 0.15.

Preferably, the upstream element has a substantially circular cross-section.

The upstream element may have an external diameter of at least about 5 millimetres, about 6 millimetres, or about 7 millimetres.

The upstream element may have an external diameter of less than or equal to 12 millimetres, less than or equal to about 10 millimetres, or less than or equal to about 8 millimetres.

The upstream element may have an external diameter of between about 5 millimetres and about 12 millimetres, between about 5 millimetres and about 10 millimetres, or between about 5 millimetres and about 8 millimetres.

The upstream element may have an external diameter of between about 6 millimetres and about 12 millimetres, between about 6 millimetres and about 10 millimetres, or between about 6 millimetres and about 8 millimetres.

The upstream element may have an external diameter of between about 7 millimetres and about 12 millimetres, between about 7 millimetres and about 10 millimetres, or between about 7 millimetres and about 8 millimetres.

For example, the upstream element may have an external diameter of about 7.1 millimetres.

Preferably, the external diameter of the upstream element is substantially the same as the external diameter of the aerosol-generating element.

Preferably, the external diameter of the upstream element is substantially the same as the external diameter of the aerosol-generating article.

As described above, the upstream element is upstream of the aerosol-generating element and may abut the aerosol-generating element. This may advantageously improve the ability of the upstream element to prevent or restrict upstream movement of aerosol-generating substrate from the aerosol-generating element.

The upstream element may be at the upstream end of the aerosol-generating article. The aerosol-generating article may comprise an additional element upstream of the upstream element. For example, an additional element upstream of the upstream element may act as a cap or cover to help avoid damage to the upstream element.

Preferably, the majority of aerosol generated by the aerosol-generating article is generated by the aerosol-generating substrate. The entirety of aerosol generated by the aerosol-generating article may be generated by the aerosol-generating substrate.

As described above, the aerosol-generating element comprises aerosol-generating substrate in the form of a rod. As used herein with reference to the invention, the term “rod” is used to denote a generally cylindrical element having a substantially circular, oval or elliptical cross-section.

The aerosol-generating element may have a length of at least about 8 millimetres, at least about 9 millimetres, or at least about 10 millimetres.

The aerosol-generating element may have a length of less than or equal to about 16 millimetres, less than or equal to about 15 millimetres, or less than or equal to about 14 millimetres.

The aerosol-generating element may have a length of between about 8 millimetres and about 16 millimetres, between about 8 millimetres and about 15 millimetres, or between about 8 millimetres and about 14 millimetres.

The aerosol-generating element may have a length of between about 9 millimetres and about 16 millimetres, between about 9 millimetres and about 15 millimetres, or between about 9 millimetres and about 14 millimetres.

The aerosol-generating element may have a length of between about 10 millimetres and about 16 millimetres, between about 10 millimetres and about 15 millimetres, or between about 10 millimetres and about 14 millimetres.

For example, the aerosol-generating element may have a length of about 12 millimetres.

The ratio between the length of the aerosol-generating element to the total length of the aerosol-generating article may be at least about 0.10, at least about 0.15, or at least about 0.20.

The ratio between the length of the aerosol-generating element to the total length of the aerosol-generating article may be less than or equal to about 0.40, less than or equal to about 0.35, or less than or equal to about 0.3.

The ratio between the length of the aerosol-generating element to the total length of the aerosol-generating article may be between about 0.10 and about 0.40, between about 0.10 and about 0.35, or between about 0.10 and about 0.30.

The ratio between the length of the aerosol-generating element to the total length of the aerosol-generating article may be between about 0.15 and about 0.40, between about 0.15 and about 0.35, or between about 0.15 and about 0.30.

The ratio between the length of the aerosol-generating element to the total length of the aerosol-generating article may be between about 0.20 and about 0.40, between about 0.20 and about 0.35, or between about 0.20 and about 0.30.

Preferably, the aerosol-generating element has a substantially circular cross-section.

The aerosol-generating element may have an external diameter of at least about 5 millimetres, about 6 millimetres, or about 7 millimetres.

The aerosol-generating element may have an external diameter of less than or equal to 12 millimetres, less than or equal to about 10 millimetres, or less than or equal to about 8 millimetres.

The aerosol-generating element may have an external diameter of between about 5 millimetres and about 12 millimetres, between about 5 millimetres and about 10 millimetres, or between about 5 millimetres and about 8 millimetres.

The aerosol-generating element may have an external diameter of between about 6 millimetres and about 12 millimetres, between about 6 millimetres and about 10 millimetres, or between about 6 millimetres and about 8 millimetres.

The aerosol-generating element may have an external diameter of between about 7 millimetres and about 12 millimetres, between about 7 millimetres and about 10 millimetres, or between about 7 millimetres and about 8 millimetres.

For example, the aerosol-generating element may have an external diameter of about 7.1 millimetres.

The aerosol-generating substrate may have a density of at least about 150 milligrams per cubic centimetre, at least about 175 milligrams per cubic centimetre, at least about 200 milligrams per cubic centimetre, or at least about 250 milligrams per cubic centimetre.

The aerosol-generating substrate may have a density of less than or equal to about 500 milligrams per cubic centimetre, less than or equal to about 450 milligrams per cubic centimetre, less than or equal to about 400 milligrams per cubic centimetre, or less than or equal to about 350 milligrams per cubic centimetre.

The aerosol-generating substrate may have a density of between about 150 milligrams per cubic centimetre and about 500 milligrams per cubic centimetre, between about 150 milligrams per cubic centimetre and about 450 milligrams per cubic centimetre, between about 150 milligrams per cubic centimetre and about 400 milligrams per cubic centimetre, or between about 150 milligrams per cubic centimetre and about 350 milligrams per cubic centimetre.

The aerosol-generating substrate may have a density of between about 175 milligrams per cubic centimetre and about 500 milligrams per cubic centimetre, between about 175 milligrams per cubic centimetre and about 450 milligrams per cubic centimetre, between about 175 milligrams per cubic centimetre and about 400 milligrams per cubic centimetre, or between about 175 milligrams per cubic centimetre and about 350 milligrams per cubic centimetre.

The aerosol-generating substrate may have a density of between about 200 milligrams per cubic centimetre and about 500 milligrams per cubic centimetre, between about 200 milligrams per cubic centimetre and about 450 milligrams per cubic centimetre, between about 200 milligrams per cubic centimetre and about 400 milligrams per cubic centimetre, or between about 200 milligrams per cubic centimetre and about 350 milligrams per cubic centimetre.

The aerosol-generating substrate may have a density of between about 250 milligrams per cubic centimetre and about 500 milligrams per cubic centimetre, between about 250 milligrams per cubic centimetre and about 450 milligrams per cubic centimetre, between about 250 milligrams per cubic centimetre and about 400 milligrams per cubic centimetre, or between about 250 milligrams per cubic centimetre and about 350 milligrams per cubic centimetre.

For example, the aerosol-generating substrate may have a density of about 300 milligrams per cubic centimetre.

The RTD of the rod of aerosol-generating substrate may be at least about 4 millimetres H₂O, at least about 5 millimetres H₂O, or at least about 6 millimetres H₂O.

The RTD of the rod of aerosol-generating substrate may be less than or equal to about 10 millimetres H₂O, less than or equal to about 9 millimetres H₂O, or less than or equal to about 8 millimetres H₂O.

The RTD of the rod of aerosol-generating substrate may be between about 4 millimetres H₂O and about 10 millimetres H₂O, between about 4 millimetres H₂O and about 9 millimetres H₂O, or between about 4 millimetres H₂O and about 8 millimetres H₂O.

The RTD of the rod of aerosol-generating substrate may be between about 5 millimetres H₂O and about 10 millimetres H₂O, between about 5 millimetres H₂O and about 9 millimetres H₂O, or between about 5 millimetres H₂O and about 8 millimetres H₂O.

The RTD of the rod of aerosol-generating substrate may be between about 6 millimetres H₂O and about 10 millimetres H₂O, between about 6 millimetres H₂O and about 9 millimetres H₂O, or between about 6 millimetres H₂O and about 8 millimetres H₂O.

The aerosol-generating substrate may be a solid aerosol-generating substrate.

The aerosol-generating substrate preferably comprises an aerosol former.

The aerosol former may be any suitable known compound or mixture of compounds that, in use, facilitates formation of a dense and stable aerosol. The aerosol former may be facilitating that the aerosol is substantially resistant to thermal degradation at temperatures typically applied during use of the aerosol-generating article. Suitable aerosol formers are for example: polyhydric alcohols such as, for example, triethylene glycol, 1,3-butanediol, propylene glycol and glycerine; esters of polyhydric alcohols such as, for example, glycerol mono-, di- or triacetate; aliphatic esters of mono-, di- or polycarboxylic acids such as, for example, dimethyl dodecanedioate and dimethyl tetradecanedioate; and combinations thereof.

Preferably, the aerosol former comprises one or more of glycerine and propylene glycol. The aerosol former may consist of glycerine or propylene glycol or of a combination of glycerine and propylene glycol.

The aerosol-generating substrate may comprise at least about 5 percent, at least about 10 percent, or at least about 12 percent by weight of aerosol former on a dry weight basis of the aerosol-generating substrate.

The aerosol-generating substrate may comprise less than or equal to about 30 percent, less than or equal to about 25 percent, or less than or equal to about 20 percent by weight of aerosol former on a dry weight basis of the aerosol-generating substrate.

The aerosol-generating substrate may comprise between about 5 percent and about 30 percent, between about 5 percent and about 25 percent, or between about 5 percent and about 20 percent by weight of aerosol former on a dry weight basis of the aerosol-generating substrate.

The aerosol-generating substrate may comprise between about 10 percent and about 30 percent, between about 10 percent and about 25 percent, or between about 10 percent and about 20 percent by weight of aerosol former on a dry weight basis of the aerosol-generating substrate.

The aerosol-generating substrate may comprise between about 12 percent and about 30 percent, between about 12 percent and about 25 percent, or between about 12 percent and about 20 percent by weight of aerosol former on a dry weight basis of the aerosol-generating substrate.

The aerosol-generating substrate may comprise a plurality of shreds of tobacco material. The aerosol-generating substrate may comprise a plurality of shreds of homogenised tobacco material.

As used herein with reference to the invention, the term “shred” denotes an element having a length substantially greater than a width and a thickness thereof.

As used herein with reference to the invention, the term “homogenised tobacco material” is used to describe material formed by agglomerating particulate tobacco material.

Shreds of homogenised tobacco material may be formed from a sheet of homogenised tobacco material, for example, by cutting or shredding. Shreds of homogenised tobacco material may be formed by other methods, for example, by extrusion.

The shreds of tobacco material may have a width of at least about 0.3 millimetres, at least about 0.5 millimetres, or at least about 0.6 millimetres.

The shreds of tobacco material may have a width of less than or equal to about 2 millimetres, less than or equal to about 1.2 millimetres, or less than about 0.9 millimetres.

The shreds of tobacco material may have a width of between about 0.3 millimetres and about 2 millimetres, between about 0.3 millimetres and about 1.2 millimetres, or between about 0.3 millimetres and about 0.9 millimetres.

The shreds of tobacco material may have a width of between about 0.5 millimetres and about 2 millimetres, between about 0.5 millimetres and about 1.2 millimetres, or between about 0.5 millimetres and about 0.9 millimetres.

The shreds of tobacco material may have a width of between about 0.6 millimetres and about 2 millimetres, between about 0.6 millimetres and about 1.2 millimetres, or between about 0.6 millimetres and about 0.9 millimetres.

The shreds of tobacco material may have a length of at least about 10 millimetres.

The shreds of tobacco material may have a length of less than or equal to about 40 millimetres.

The shreds of tobacco material may have a length of between about 10 millimetres and about 40 millimetres.

At least about 20 percent by weight of the plurality of shreds of tobacco material on a dry weight basis may extend along the entire length of the aerosol-generating substrate. At least about 20 percent by weight of the plurality of shreds of tobacco material on a dry weight basis may have a length substantially the same as the length of the aerosol-generating substrate.

Less than or equal to about 60 percent by weight of the plurality of shreds of tobacco material on a dry weight basis may extend along the entire length of the aerosol-generating substrate. Less than or equal to about 60 percent by weight of the plurality of shreds of tobacco material on a dry weight basis may have a length substantially the same as the length of the aerosol-generating substrate.

Between about 20 percent and 60 percent by weight of the plurality of shreds of tobacco material on a dry weight basis may extend along the entire length of the aerosol-generating substrate. Between about 20 percent and 60 percent by weight of the plurality of shreds of tobacco material on a dry weight basis may have a length substantially the same as the length of the aerosol-generating substrate.

The size of the aerosol-generating material of the aerosol-generating substrate, such as a plurality of shreds of tobacco material, may play a role in the distribution of heat inside the aerosol-generating substrate. Also, the size of the aerosol-generating material may play a role in the resistance to draw of the article. In addition, the size of the aerosol-generating material may affect the ability of the upstream element to prevent or restrict movement of the aerosol-generating material into the longitudinally extending channels of the upstream element. The size of the aerosol-generating material may also affect the ability of the upstream element to prevent or restrict upstream movement of the aerosol-generating material along the longitudinally extending channels and out of the upstream element.

The aerosol-generating substrate may comprise a plurality of pellets or granules of tobacco material. The aerosol-generating substrate may comprise a plurality of pellets or granules of homogenised tobacco material.

At least about 60 percent by weight of the plurality of pellets or granules may have a largest dimension greater than about 1 millimetre, at least about 70 percent by weight of the plurality of pellets or granules may have a largest dimension greater than about 1 millimetre, or at least about 80 percent by weight of the plurality of pellets or granules may have a largest dimension greater than about 1 millimetre.

Where the homogenised plant material is in the form of a plurality of pellets or granules, at least about 70 percent by weight of the plurality of pellets or granules may have a largest dimension greater than about 0.5 millimetres, at least about 80 percent by weight of the plurality of pellets or granules may have a largest dimension greater than about 0.5 millimetres, or at least about 90 percent by weight of the plurality of pellets or granules may have a largest dimension greater than about 0.5 millimetres.

For example, at least about 80 percent by weight of the plurality of pellets or granules may have a largest dimension greater than about 1 millimetre and at least about 90% by weight of the plurality of pellets or granules may have a largest dimension greater than about 0.5 millimetres.

The aerosol-generating substrate may comprise one or more sheets of tobacco material.

The aerosol-generating substrate may comprise one or more sheets of homogenised tobacco material.

The one or sheets of tobacco material may each individually have a thickness of at least about 100 micrometres, at least about 150 micrometres, or at least about 300 micrometres.

As used herein with reference to the invention, individual thickness refers to the thickness of the individual sheet of tobacco material, whereas combined thickness refers to the total thickness of all sheets of tobacco material that make up the aerosol-generating substrate. For example, if the aerosol-generating substrate is formed from two individual sheets of tobacco material, then the combined thickness is the sum of the thickness of the two individual sheets of tobacco material or the measured thickness of the two sheets of tobacco material where the two sheets of tobacco material are stacked in the aerosol-generating substrate.

The one or more sheets of tobacco material may each individually have a thickness of less than or equal to about 600 micrometres, less than or equal to about 300 micrometres, or less than or equal to about 250 micrometres.

The one or more sheets of tobacco material may each individually have a thickness of between about 100 micrometres and about 600 micrometres, between about 100 micrometres and about 300 micrometres, or between about 100 micrometres and about 250 micrometres.

The one or more sheets of tobacco material may each individually have a thickness of between about 150 micrometres and about 600 micrometres, between about 150 micrometres and about 300 micrometres, or between about 150 micrometres and about 250 micrometres.

The one or more sheets of tobacco material may each individually have a thickness of between about 250 micrometres and about 600 micrometres, between about 250 micrometres and about 300 micrometres, or between about 250 micrometres and about 250 micrometres.

The one or more sheets of tobacco material may each individually have a length substantially the same as the length of the aerosol-generating substrate.

The one or more sheets of tobacco material may have been one or more of crimped, folded, gathered, and pleated.

Crimping, folding, gathering, or pleating of the one or more sheets of tobacco material may cause splitting of the one or more sheets of tobacco material to form shreds of tobacco material. For example, the one or more sheets of tobacco material may be crimped to such an extent that the integrity of the one or more sheets of tobacco material becomes disrupted at the plurality of parallel ridges or corrugations causing separation of the material, and results in the formation of shreds of tobacco material.

The aerosol-generating article may comprise a susceptor arranged within the aerosol-generating substrate.

As used herein with reference to the present invention, the term “susceptor” refers to a material that can convert electromagnetic energy into heat. When located within a fluctuating electromagnetic field, eddy currents induced in the susceptor cause heating of the susceptor.

The susceptor is arranged in thermal contact with the aerosol-generating substrate. Thus, when the susceptor heats up, the aerosol-generating substrate is heated by the susceptor to generate an aerosol. The susceptor may be arranged in direct physical contact with the aerosol-generating substrate.

The upstream element may advantageously prevent or restrict upstream movement of the susceptor during storage, transportation and use of the aerosol-generating article.

The susceptor may be an elongate susceptor.

As used herein with reference to the invention, the term “elongate” is used to describe a component of the aerosol-generating article having a length greater than the width and thickness thereof.

The elongate susceptor may be arranged substantially longitudinally within the aerosol-generating substrate. That is, the longitudinal axis of the elongate susceptor may be approximately parallel to the longitudinal axis of the aerosol-generating element. For example, the longitudinal axis of the elongate susceptor may be within plus or minus 10 degrees of parallel to the longitudinal axis of the aerosol-generating element. The elongate susceptor may be located in a radially central position within the rod of aerosol-generating substrate, and extend along the longitudinal axis of the aerosol-generating element.

The susceptor may extend from the downstream end of the aerosol-generating element towards the upstream end of the aerosol-generating element.

The susceptor may extend from the upstream end of the aerosol-generating element towards the downstream end of the aerosol-generating element.

The susceptor may extends from the upstream end of the aerosol-generating substrate to the downstream end of the aerosol-generating element. That is, the susceptor may extend along the entire length of the aerosol-generating element.

The length of the susceptor may be substantially the same as the length of the aerosol-generating element.

The susceptor may extend part way along the length of the aerosol-generating element.

The susceptor may be spaced apart from the downstream end of the aerosol-generating substrate.

The susceptor may be spaced apart from the upstream end of the aerosol-generating element.

The susceptor may be spaced apart from both a downstream end and an upstream end of the aerosol-generating element.

The length of the susceptor may be less than the length of the aerosol-generating element.

The susceptor may be entirely enclosed within the aerosol-generating substrate. That is, the aerosol-generating substrate may completely surround the susceptor.

The susceptor may be in the form of a pin, rod, strip or blade.

The susceptor may have a length of at least about 5 millimetres, at least about 6 millimetres, or at least about 8 millimetres.

The susceptor may have a length of less than or equal to about 15 millimetres, less than or equal to about 12 millimetres, or less than or equal to about 10 millimetres.

The susceptor may have a length of between about 5 millimetres and about 15 millimetres, between about 5 millimetres and about 12 millimetres, or between about 5 millimetres and about 10 millimetres.

The susceptor may have a length of between about 6 millimetres and about 15 millimetres, between about 6 millimetres and about 12 millimetres, or between about 6 millimetres and about 10 millimetres.

The susceptor may have a length of between about 8 millimetres and about 15 millimetres, between about 8 millimetres and about 12 millimetres, or between about 8 millimetres and about 10 millimetres.

The susceptor may have a width of at least about 1 millimetre.

The susceptor may have width of less than or equal to about 5 millimetres.

The susceptor may have a width of between about 1 millimetre and about 5 millimetres.

The susceptor may have a thickness of at least about 0.01 millimetres, or at least about 0.5 millimetres.

The susceptor may have a thickness of less than or equal to about 2 millimetres, less than or equal to about 500 micrometres, or less than or equal to about 100 micrometres.

The susceptor may have a thickness of between about 10 micrometres and about 2 millimetres, between about 10 micrometres and about 500 micrometres, or between about 10 micrometres and about 100 micrometres.

The susceptor may have a thickness of between about 0.5 millimetres and about 2 millimetres.

The susceptor may have a substantially circular cross-section.

The susceptor may have a substantially constant cross-section along the length of the susceptor.

If the susceptor has the form of a strip or blade, the strip or blade may have a rectangular shape having a width of between about 2 millimetres to about 8 millimetres, or between about 3 millimetres to about 5 millimetres. By way of example, a susceptor in the form of a strip of blade may have a width of about 4 millimetres.

If the susceptor has the form of a strip or blade, the strip or blade may have a rectangular shape and a thickness of between about 0.03 millimetres to about 0.15 millimetres, or between about 0.05 millimetres to about 0.09 millimetres. By way of example, a susceptor in the form of a strip of blade may have a thickness of about 0.07 millimetres, or about 0.06 millimetres.

The susceptor may be formed from any material that can be inductively heated to a temperature sufficient to generate an aerosol from the aerosol-generating substrate. For example, the susceptor may comprise a metal or carbon.

The susceptor may comprise or consist of a ferromagnetic material, for example a ferromagnetic alloy, ferritic iron, or a ferromagnetic steel or stainless steel. A suitable susceptor may be, or comprise, aluminium. The susceptor may be formed from 400 series stainless steels, for example grade 410, or grade 420, or grade 430 stainless steel. Different materials will dissipate different amounts of energy when positioned within electromagnetic fields having similar values of frequency and field strength.

Thus, parameters of the susceptor such as material type, length, width, and thickness may all be altered to provide a desired power dissipation within a known electromagnetic field. The susceptor may be heated to a temperature in excess of 250 degrees Celsius.

Suitable susceptors may comprise a non-metallic core with a metal layer disposed on the non-metallic core, for example metallic tracks formed on a surface of a ceramic core. A susceptor may have a protective external layer, for example a protective ceramic layer or protective glass layer encapsulating the susceptor. The susceptor may comprise a protective coating formed by a glass, a ceramic, or an inert metal, formed over a core of susceptor material.

The susceptor may be a multi-material susceptor and may comprise a first susceptor material and a second susceptor material.

In the context of the present invention, the hollow tubular element provides an unrestricted flow channel. This means that the hollow tubular element provides a negligible level of resistance to draw (RTD). As used herein with reference to the invention, the term “negligible level of RTD” is used to describe an RTD of less than 1 mm H₂O per 10 millimetres of length of the hollow tubular substrate element, less than 0.4 mm H₂O per 10 millimetres of length of the hollow tubular substrate element, or less than 0.1 mm H₂O per 10 millimetres of length of the hollow tubular substrate element. The flow channel should therefore be free from any components that would obstruct the flow of air in a longitudinal direction. Preferably, the flow channel is substantially empty.

The hollow tubular element may have a total length of at least about 10 millimetres, at least about 12 millimetres, or at least about 15 millimetres.

The hollow tubular element may have a total length of less than or equal to about 30 millimetres, less than or equal to about 25 millimetres, or less than or equal to about 23 millimetres.

The hollow tubular element may have a total length of between about 10 millimetres and about 30 millimetres, between about 10 millimetres and about 25 millimetres, or between about 10 millimetres and about 23 millimetres.

The hollow tubular element may have a total length of between about 12 millimetres and about 30 millimetres, between about 12 millimetres and about 25 millimetres, or between about 12 millimetres and about 23 millimetres.

The hollow tubular element may have a total length of between about 12 millimetres and about 30 millimetres, between about 12 millimetres and about 25 millimetres, or between about 12 millimetres and about 23 millimetres.

The total length of the hollow tubular element may be selected based on a desired total length of the aerosol-generating article.

The hollow tubular element may be formed from any suitable material or combination of materials. For example, the hollow tubular element may be formed from one or more materials selected from the group consisting of: cellulose acetate; a paper based material such as paper or cardboard; and polymeric materials, such as low density polyethylene (LDPE). Other suitable materials include polyhydroxyalkanoate (PHA) fibres.

In some embodiments, a ventilation zone may be provided at a location downstream of the aerosol-generating element. A satisfactory cooling of the stream of aerosol generated upon heating the aerosol-generating substrate and drawn through the hollow tubular element may be achieved by providing a ventilation zone at a location along the hollow tubular element itself or at a location along an intermediate element provided between the hollow tubular element and the mouthpiece. One such intermediate element may also be described as an aerosol-cooling element. One such intermediate element may also be provided in the form of a hollow tubular element. Without wishing to be bound by theory, the temperature drop caused by the admission of cooler, external air into the aerosol-generating article downstream of the aerosol-generating element via the ventilation zone may have an advantageous effect on the nucleation and growth of aerosol particles.

The ventilation zone may comprise a plurality of perforations through a tubular wall of the hollow tubular element. The ventilation zone may comprise at least one circumferential row of perforations. The ventilation zone may comprise two circumferential rows of perforations. For example, the perforations may be formed online during manufacturing of the aerosol-generating article. Each circumferential row of perforations may comprise from 8 to 30 perforations.

As mentioned above, the aerosol-generating article may comprise a mouthpiece element located downstream of the aerosol-generating substrate and at the downstream end or mouth end or proximal end of the aerosol-generating article.

The mouthpiece element may be a mouthpiece filter element. The mouthpiece element may comprise at least one filter segment for filtering aerosol generated upon heating the aerosol-generating substrate. For example, the mouthpiece element may comprise one or more segments of a fibrous filtration material. Suitable fibrous filtration materials are known in the art. For example, the at least one mouthpiece filter segment may comprise a cellulose acetate filter segment formed of cellulose acetate tow.

The mouthpiece element may consist of a single filter segment. The mouthpiece element may include two or more filter segments axially aligned in an abutting end to end relationship with each other.

Parameters or characteristics described herein in relation to the mouthpiece element as a whole may equally be applied to a filter segment of the mouthpiece element.

The mouthpiece element may have a low particulate filtration efficiency.

The mouthpiece element may have an RTD of less than or equal to about 25 millimetres H₂O, less than or equal to about 20 millimetres H₂O, or less than or equal to about 15 millimetres H₂O.

The mouthpiece element may have an RTD of at least about 10 millimetres H₂O.

The mouthpiece element may have an RTD of between about 10 millimetres H₂O and to about 25 millimetres H₂O, between about 10 millimetres H₂O and to about 20 millimetres H₂O, or of between about 10 millimetres H₂O and to about 15 millimetres H₂O.

Preferably, the mouthpiece element has a substantially circular cross-section.

Preferably, the mouthpiece element has an external diameter that is substantially the same as the external diameter of the aerosol-generating article.

The mouthpiece element may have a length of at least about 3 millimetres, or at least about 5 millimetres.

The length of the mouthpiece element may be less than or equal to about 11 millimetres, or less than or equal to about 9 millimetres.

The length of the mouthpiece element may be between about 3 millimetres and about 11 millimetres, or between about 3 millimetres and about 9 millimetres.

The length of the mouthpiece element may be between about 5 millimetres and about 11 millimetres, or between about 5 millimetres and about 9 millimetres.

For example, the length of the mouthpiece element may be about 7 millimetres.

The length of the mouthpiece element may be selected based on a desired total length of the aerosol-generating article.

The mouthpiece element may be circumscribed by a plug wrap.

The mouthpiece element may be unventilated such that air does not enter the aerosol-generating article along the mouthpiece element.

The mouthpiece element may be connected to one or more adjacent components of the aerosol-generating article by means of a tipping wrapper.

The aerosol-generating article may comprise a mouth end cavity at the downstream end of the aerosol-generating article. The mouth end cavity may be downstream of the mouthpiece element, where present.

The mouth end cavity may be defined by a hollow tubular element provided at the downstream end of the mouthpiece. Alternatively, the mouth end cavity may be defined by an outer wrapper of the mouthpiece element, wherein the outer wrapper extends in a downstream direction from the mouthpiece element.

The aerosol-generating article may have a total length of at least about 35 millimetres, at least about 38 millimetres, at least about 40 millimetres, or at least about 42 millimetres.

The aerosol-generating article may have a total length of less than or equal to about 100 millimetres, less than or equal to about 70 millimetres, less than or equal to about 60 millimetres, or less than or equal to 50 millimetres.

The aerosol-generating article may have a total length of between about 35 millimetres and about 100 millimetres, between about 35 millimetres and about 70 millimetres, between about 35 millimetres and about 60 millimetres, or between about 35 millimetres and about 50 millimetres.

The aerosol-generating article may have a total length of between about 38 millimetres and about 100 millimetres, between about 38 millimetres and about 70 millimetres, between about 38 millimetres and about 60 millimetres, or between about 38 millimetres and about 50 millimetres.

The aerosol-generating article may have a total length of between about 40 millimetres and about 100 millimetres, between about 40 millimetres and about 70 millimetres, between about 40 millimetres and about 60 millimetres, or between about 40 millimetres and about 50 millimetres.

The aerosol-generating article may have a total length of between about 42 millimetres and about 100 millimetres, between about 42 millimetres and about 70 millimetres, between about 42 millimetres and about 60 millimetres, or between about 42 millimetres and about 50 millimetres.

For example, the aerosol-generating article may have a total length of about 45 millimetres.

Preferably, the aerosol-generating article has a substantially circular cross-section.

The aerosol-generating article may have an external diameter of at least about 5 millimetres, at least about 6 millimetres, or at least about 7 millimetres.

The aerosol-generating article may have an external diameter of less than or equal to about 12 millimetres, less than or equal to about 10 millimetres, or less than or equal to about 8 millimetres.

The aerosol-generating article may have an external diameter of between about 5 millimetres and about 12 millimetres, between about 5 millimetres and about 10 millimetres, or between about 5 millimetres and about 8 millimetres.

The aerosol-generating article may have an external diameter of between about 6 millimetres and about 12 millimetres, between about 6 millimetres and about 10 millimetres, or between about 6 millimetres and about 8 millimetres.

The aerosol-generating article may have an external diameter of between about 7 millimetres and about 12 millimetres, between about 7 millimetres and about 10 millimetres, or between about 7 millimetres and about 8 millimetres.

For example, the aerosol-generating article may have an external diameter of about 7.1 millimetres.

In aerosol-generating articles in accordance with the present invention, a flavour material having the structure and formulation described above is provided at a location in at least one of the upstream section, the downstream section, or in the wrapper circumscribing the aerosol-generating substrate of the aerosol-generating element. Incorporation of a flavour material in an aerosol-generating article according to the present invention may be carried out according to one of several routes.

For example, pieces of the flavour material may be combined into a tow of cellulose acetate fibres from which an upstream element or a hollow tubular element can be formed. As an alternative, pieces of the flavour material may be incorporated into the plug wrapper used to circumscribe the rod of aerosol-generating substrate of the aerosol-generating element.

As a further alternative, a flavour material comprising a carrier sheet material in the form of a paper wrapper may be used, alone or in combination with another paper wrapper, to circumscribe the rod of aerosol-generating substrate.

As a further alternative, pieces of the flavour material may be sandwiched between the upstream element and the aerosol-generating element, or between the hollow tubular element and the aerosol-generating element.

Incorporating a flavour material as described above at one or more of the locations within the aerosol-generating article discussed here has been found to have an impact on the flavour release profile and the flavour transfer rate during use of the aerosol-generating article. Without wishing to be bound by theory, this is because—in contrast to solutions known in the art, according to which a flavour material has been provided at a location within the rod of aerosol-generating substrate—in aerosol-generating articles in accordance with the present invention the flavour material is generally exposed to a less intense heating compared with the aerosol-generating substrate. This is linked to an average distance between the flavour material and the heat source being generally larger than a distance between the aerosol-generating substrate and the same heat source. The mutual arrangement and interaction of aerosol-generating articles in accordance with the invention and an aerosol-generating device configured to heat the aerosol-generating substrate will be discussed in more detail below.

Besides, aerosol-generating articles wherein an aerosol-generating substrate is heated to generate an aerosol—as opposed to being combusted to generate a smoke—are typically heated to relatively low temperatures.

The inventors have found that aerosol-generating articles in accordance with the invention are capable of providing satisfactory flavour transfer rate during use as the flavour materials can be adapted to release flavour in controlled fashion within a predetermined temperature range. This can be achieved a) by selecting and adjusting the polysaccharide matrix composition or b) by including (in line with the foregoing description) in the flavour material carbon particles or c) by including (in line with the foregoing description) in the flavour material additives capable of generating gaseous compounds when they decompose thermally or d) by any combination of a), b) and c).

As such, although it is exposed to less intense heating, a flavour material included in aerosol-generating articles in accordance with the present invention is capable of releasing flavour in more consistent fashion throughout the use cycle of the aerosol-generating article. For example, with some embodiments the inventors have observed that the flavour release associated with consecutive puffs during use of an aerosol-generating article may remain substantially constant until the last puff or even increase slightly towards the end of the use cycle. This is rather surprising and in contrast to what is typically found when a flavour material is incorporated within the aerosol-generating substrate, namely that the flavour release increases during the first few puffs and reaches a maximum, only to decrease gradually as the consumer approaches the end of the use cycle.

In embodiments wherein the flavour material is provided at a location in the upstream section or in the downstream section, a distance between the flavour material and the aerosol-generating element may be at least 5 percent of an outer diameter of the aerosol-generating element. The distance between the flavour material and the aerosol-generating element is measured as the linear distance between a geometric centre of the flavour material and the closest end surface of the aerosol-generating element. For example, if the flavour material is provided in the upstream section, such as in the upstream element, the distance between the flavour material and the aerosol-generating element is measured as the linear distance between the geometric centre of the flavour material and the upstream end of the rod of aerosol-generating substrate.

Preferably, a distance between the flavour material and the aerosol-generating element may be at least 10 percent of an outer diameter of the aerosol-generating element. More preferably, a distance between the flavour material and the aerosol-generating element may be at least 15 percent of an outer diameter of the aerosol-generating element.

In embodiments wherein the flavour material is provided at a location in the upstream section or in the downstream section, a distance between the flavour material and the aerosol-generating element is preferably less than or equal to 50 percent of an outer diameter of the aerosol-generating element. More preferably, a distance between the flavour material and the aerosol-generating element is preferably less than or equal to 40 percent of an outer diameter of the aerosol-generating element. Even more preferably, a distance between the flavour material and the aerosol-generating element is preferably less than or equal to 30 percent of an outer diameter of the aerosol-generating element.

In some embodiments wherein the flavour material is provided at a location in the section or in the downstream section, such as in the upstream element or in the hollow tubular element, a distance between the flavour material and the aerosol-generating element is from 5 percent to 50 percent of an outer diameter of the aerosol-generating element, preferably from 5 percent to 40 percent of an outer diameter of the aerosol-generating element, more preferably from 5 percent to 30 percent of an outer diameter of the aerosol-generating element.

In other embodiments wherein the flavour material is provided at a location in the upstream section or in the downstream section, such as in the upstream element or in the hollow tubular element, a distance between the flavour material and the aerosol-generating element is from 10 percent to 50 percent of an outer diameter of the aerosol-generating element, preferably from 10 percent to 40 percent of an outer diameter of the aerosol-generating element, more preferably from 10 percent to 30 percent of an outer diameter of the aerosol-generating element.

In further embodiments wherein the flavour material is provided at a location in the upstream section or in the downstream section, such as in the upstream element or in the hollow tubular element, a distance between the flavour material and the aerosol-generating element is from 15 percent to 50 percent of an outer diameter of the aerosol-generating element, preferably from 15 percent to 40 percent of an outer diameter of the aerosol-generating element, more preferably from 15 percent to 30 percent of an outer diameter of the aerosol-generating element.

The present disclosure also relates to an aerosol-generating system. The aerosol-generating system may comprise an aerosol-generating article as described above. The aerosol-generating system may further comprise an aerosol-generating device configured to heat the aerosol-generating substrate of the aerosol-generating article. The aerosol-generating device may comprise a housing defining a cavity configured to receive the aerosol-generating article.

According to a second aspect of the present invention, there is provided an aerosol-generating system comprising: an aerosol-generating article according to the first aspect of the invention; and an aerosol-generating device configured to heat the aerosol-generating substrate of the aerosol-generating article, wherein the aerosol-generating device comprises a housing defining a cavity configured to receive the aerosol-generating article.

The aerosol-generating device may be a handheld aerosol-generating device.

The aerosol-generating device may be an electrically-operated aerosol-generating device.

The aerosol-generating device may comprise a power supply and control electronics.

The aerosol-generating device may comprise a battery and control electronics.

The aerosol-generating device may be configured to heat the aerosol-generating substrate internally. That is, the aerosol-generating device may be configured to supply heat to the aerosol-generating substrate from a location internal to the aerosol-generating article.

For example, in some embodiments the aerosol-generating device comprises a heater element configured to be inserted into the aerosol-generating element when the aerosol-generating article is received within the cavity of the aerosol-generating device.

In other embodiments, the aerosol-generating article comprises a susceptor element provided at a location within the aerosol-generating element, and the aerosol-generating device comprises an inductor coil positioned on or within the housing, a power supply of the aerosol-generating device being connected to the inductor coil and configured to provide a high frequency oscillating current to the inductor coil. This generates an alternating magnetic field that induces a voltage in the susceptor element. The induced voltage causes a current to flow in the susceptor element, and this current causes Joule heating of the susceptor element that, in turn, heats the aerosol-generating substrate. The aerosol-generating device may be capable of generating a fluctuating electromagnetic field having a magnetic field strength (H-field strength) of between 1 and 5 kilo amperes per metre (kA m), preferably between 2 and 3 kA/m, for example about 2.5 kA/m.

The aerosol-generating device may be configured to heat the aerosol-generating substrate internally. That is, the aerosol-generating device may be configured to supply heat to the aerosol-generating substrate from a location external to the aerosol-generating article.

For example, in some embodiments the aerosol-generating device comprises a heater element located about a perimeter of the cavity and configured to heat the aerosol-generating substrate of the aerosol-generating article from an exterior of the aerosol-generating element of the aerosol-generating article.

The invention is defined in the claims. However, below there is provided a non-exhaustive list of non-limiting examples. Any one or more of the features of these examples may be combined with any one or more features of another example, embodiment, or aspect described herein.

Example Ex1: An aerosol-generating article for generating an aerosol upon heating, the aerosol-generating article comprising: an aerosol-generating element comprising a rod of aerosol-generating substrate circumscribed by a wrapper; a downstream section provided immediately downstream of the aerosol-generating element and extending from a downstream end of the aerosol-generating element to a downstream end of the aerosol-generating article; and an upstream section provided immediately upstream of the aerosol-generating element and extending from an upstream end of the aerosol-generating element to an upstream end of the aerosol-generating article; wherein the aerosol-generating article comprises a flavour material provided in at least one of the wrapper circumscribing the rod of aerosol-generating substrate, the downstream section, and the upstream section; wherein the flavour material comprises: a polysaccharide matrix structure comprising gellan gum and emulsifier; and a flavourant formulation dispersed within the polysaccharide matrix structure, wherein the flavourant formulation is at least partly trapped within the polysaccharide matrix structure and releasable from the polysaccharide matrix structure upon heating of the flavour material.

Example Ex2: An aerosol-generating article according to Example Ex1, wherein the downstream section comprises a hollow tubular element provided immediately downstream of the aerosol-generating element, an upstream end of the hollow tubular element abutting a downstream end of the aerosol-generating element; wherein the flavour material is provided in the hollow tubular element.

Example Ex3: An aerosol-generating article according to Example Ex1, wherein the upstream section comprises an upstream element provided immediately upstream of the aerosol-generating element, a downstream end of the upstream element abutting an upstream end of the aerosol-generating element; wherein the flavour material is provided in the upstream element.

Example Ex4: An aerosol-generating article according to any one of Examples Ex1 to Ex3, wherein the polysaccharide matrix structure comprises gellan gum as the sole polysaccharide or gellan gum in combination with at least a further polysaccharide selected from the group consisting of guar, tamarind gum, sodium alginate, xanthan gum, sodium carboxymethyl cellulose, and hydroxypropyl methyl cellulose.

Example Ex5: An aerosol-generating article according to any one of Examples Ex1 to Ex4, wherein the gellan gum accounts for from 5 percent by weight to 99.9 percent by weight of the flavour material on a dry weight basis.

Example Ex6: An aerosol-generating article according to any one of Examples Ex1 to Ex5, further comprising a polyol having the formula CₙH₂ₙ₊₂Oₙ.

Example Ex7: An aerosol-generating article according to Example Ex6, wherein the polyol is selected from the group consisting of glycerol, sorbitol, xylitol, mannitol, and erythritol.

Example Ex8: An aerosol-generating article according to Example Ex6 or Example Ex7, wherein the polyol accounts from 0.01 percent by weight to 20 percent by weight of the flavour material on a dry weight basis.

Example Ex9: An aerosol-generating article according to any one of the preceding Examples further comprising fibres.

Example Ex10: An aerosol-generating article according to Example Ex9, wherein the fibres account for from 0.01 percent by weight to 10 percent by weight of the flavour material on a dry weight basis.

Example Ex11: An aerosol-generating article according to any one of the preceding Examples comprising from 0.01 percent by weight to 80 percent by weight of menthol.

Example Ex12: An aerosol-generating article according to any one of the preceding Examples, wherein the flavour material further comprises a carrier material, wherein the polysaccharide matrix structure and the flavourant formulation are supported by the carrier material.

Example Ex13: An aerosol-generating article according to Example Ex12, wherein the carrier material is a sheet of homogenised tobacco material.

Example Ex14: An aerosol-generating article according to Example Ex12, wherein the carrier material is a sheet of plug paper wrapper material.

Example Ex15: An aerosol-generating article according to any one of the preceding Examples, the article comprising a ventilation zone at a location along the hollow tubular element, the ventilation zone configured to enable ingress of air into an axial lumen of the hollow tubular element.

Example Ex16: An aerosol-generating article according to any one of the preceding Examples, wherein the upstream element comprises a plug extending to and defining the distal end of the aerosol-generating article, the flavour material being provided at a location within the plug.

Example Ex17: An aerosol-generating article according to any one of the preceding Examples, wherein the aerosol-generating substrate comprises a tobacco material.

Example Ex18: An aerosol-generating article according to Example Ex17, wherein the tobacco material comprises a sheet of homogenised tobacco material.

Example Ex19: An aerosol-generating article according to Example Ex17, wherein the tobacco material comprises one or more of tobacco cut filler, cut reconstituted tobacco, and cut homogenised tobacco material.

Example Ex20: An aerosol-generating system comprising: an aerosol-generating article according to any one of Examples Ex1 to Ex19; and an aerosol-generating device configured to heat the aerosol-generating substrate of the aerosol-generating article, wherein the aerosol-generating device comprises a housing defining a cavity configured to receive the aerosol-generating article.

Example Ex21: An aerosol-generating system according to Example Ex20, wherein the aerosol-generating device comprises a heater element configured to be inserted into the aerosol-generating element when the aerosol-generating article is received within the cavity of the aerosol-generating device.

Example Ex22: An aerosol-generating system according to Example Ex20, wherein the aerosol-generating article comprises a susceptor element provided at a location within the aerosol-generating element; and wherein the aerosol-generating device comprises an inductor coil positioned on or within the housing, and a power supply connected to the inductor coil and configured to provide a high frequency oscillating current to the inductor coil.

Example Ex23: An aerosol-generating system according to Example Ex20, wherein the aerosol-generating device comprises a heater element located about a perimeter of the cavity and configured to heat the aerosol-generating substrate of the aerosol-generating article from an exterior of the aerosol-generating element of the aerosol-generating article.

Examples will now be further described with reference to the figures in which:

FIG. 1 shows a schematic side cross-sectional view of an aerosol-generating article in accordance with the present invention comprising a flavour material in the upstream element;

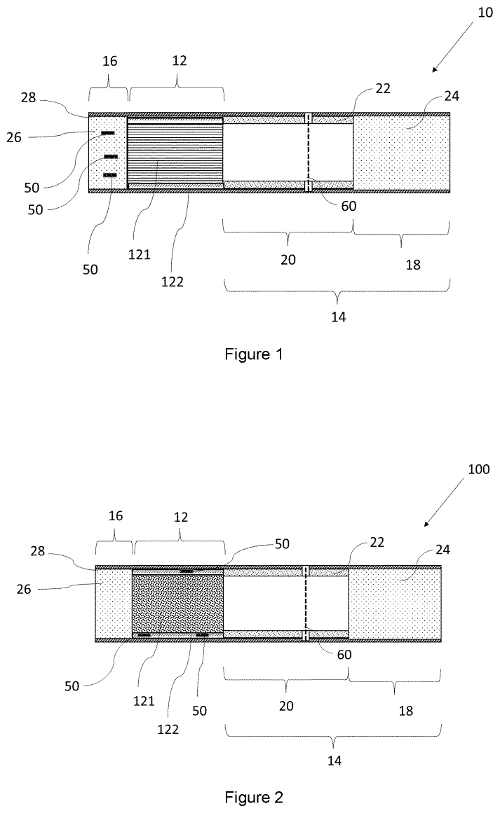

FIG. 2 shows a schematic side cross-sectional view of another aerosol-generating article in accordance with the present invention comprising a flavour material in the wrapper circumscribing the aerosol-generating substrate of the aerosol-generating element;

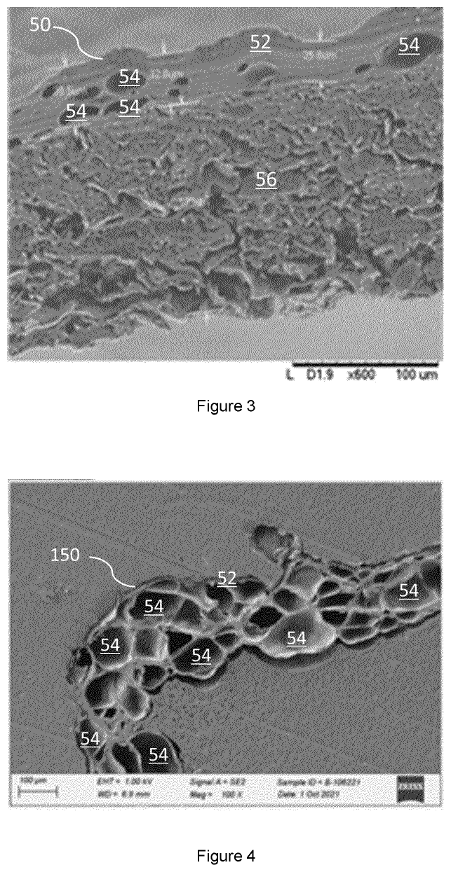

FIG. 3 shows a scanning electron microscope image of the flavour material used in the aerosol-generating articles of FIGS. 1 and 2; and

FIG. 4 shows a scanning electron microscope image of another flavour material suitable for use in the aerosol-generating articles in accordance with the present invention.

An aerosol-generating article 10 in accordance with the present invention is shown in FIG. 1. The aerosol-generating article 10 shown in FIG. 1 comprises an aerosol-generating element 12 and a downstream section 14 at a location downstream of the aerosol-generating element 12. Further, the aerosol-generating article 10 comprises an upstream section 16 at a location upstream of the aerosol-generating element 12.

The aerosol-generating element 12 comprises a rod 121 of aerosol-generating substrate and a wrapper 122 circumscribing the rod 121.

A ventilation zone 60 is provided at a location downstream of the aerosol-generating element 12.

In more detail, in the embodiment of FIG. 1, the downstream section 14 comprises a mouthpiece element 18 and a hollow section 20. The hollow section 20 comprises an aerosol-cooling element 22 comprising a hollow tubular element and the ventilation zone 60, which comprises a plurality of openings formed through a wall of the hollow tubular element. The aerosol-cooling element 22 is positioned immediately downstream of the aerosol-generating element 12. As shown in the drawing of FIG. 1, an upstream end of the aerosol-cooling element 22 abuts a downstream end of the aerosol-generating element 12. The mouthpiece element 18 is positioned immediately downstream of the aerosol-cooling element 22. As shown in the drawing of FIG. 1, an upstream end of the mouthpiece element 18 abuts a downstream end of the aerosol-cooling element 22. The mouthpiece element 18 comprises a plug 24 of low-density filtration material.

The aerosol-generating substrate 121 is in the form of a gathered sheet of homogenised tobacco material. However, other types of tobacco-containing substrate, such as a tobacco cut filler, can replace the gathered sheet of homogenised tobacco material.

The upstream section 16 comprises a cylindrical plug 26 of compressed and plasticised cellulose acetate circumscribed by a wrapper 28. The plug 26 of the upstream section 16 has a length of about 5 millimetres.

Further, the aerosol-generating article comprises a flavour material 50. In more detail, a plurality of pieces of a flavour material in sheet form are dispersed within the cylindrical plug 26. The flavour material 50 is of the type described in detail above.

Another aerosol-generating article 100 in accordance with the present invention is shown in FIG. 2. The aerosol-generating article 100 shown in FIG. 2 has substantially the same structure and geometry of the aerosol-generating 10 shown in FIG. 1, and will be described below only insofar as it differs from the aerosol-generating 10 shown in FIG. 1.

In the aerosol-generating article 100, the aerosol-generating substrate 121 is in the form of shreds of a homogenised tobacco material. However, other types of tobacco-containing substrate, such as a tobacco cut filler or a gathered sheet of homogenised tobacco material can replace the shreds of homogenised tobacco material.

Further, in the aerosol-generating article 100 the flavour material 50 is provided in the wrapper 122 circumscribing the aerosol-generating substrate 121.

### Preparation A—Flavour Material Comprising a Menthol Formulation Trapped in a Gellan Gum Polysaccharide Matrix

100 g of water are heated to about 60 degrees Celsius and 3.0 g of gellan gum are added to the water bath. The resulting mixture is homogenized and heated to a temperature in the range from 80 to 85 degrees Celsius and kept at this temperature for 5 minutes. The mixture is subsequently cooled down to a temperature in the range from 70 to 75 degrees Celsius and 0.1 g of lecithin, 1.1 g of graphite and 8.0 g of menthol are added to the mixture. The flavour-containing mixture is homogenized for 3 minutes. Subsequently, the resulting aqueous composition is cast on a metallic tray, left to jellify and dried in a still oven at 65 degrees Celsius. A flavour material in sheet form is obtained.

### Preparation B—Flavour Material Comprising a Menthol Formulation Trapped in a Gellan Gum-Guar Polysaccharide Matrix

100 g of water are heated to about 60 degrees Celsius and 1.0 g of gellan gum are added to the water bath. The resulting mixture is homogenized and heated to a temperature in the range from 80 to 85 degrees Celsius and kept at this temperature for 5 minutes. The mixture is subsequently cooled down to a temperature in the range from 70 to 75 degrees Celsius and 0.1 g of lecithin, 1.1 g of graphite and 8.0 g of menthol are added to the mixture. The flavour-containing mixture is homogenized for 3 minutes. Subsequently, 2.0 g of guar are added to the mixture, which is then homogenised again for another 3 minutes. Subsequently, the resulting aqueous composition is cast on a metallic tray, left to jellify and dried in a still oven at 75 degrees Celsius. A flavour material in sheet form is obtained.

### Preparation C—Flavour Material Comprising a Menthol Formulation Trapped in a Gellan Gum Polysaccharide Matrix Supported on a Carrier Sheet Material (Paper Wrapper)

100 g of water are heated to about 60 degrees Celsius and 3.0 g of gellan gum are added to the water bath. The resulting mixture is homogenized and heated to a temperature in the range from 80 to 85 degrees Celsius and kept at this temperature for 5 minutes. The mixture is subsequently cooled down to a temperature in the range from 70 to 75 degrees Celsius and 0.1 g of lecithin and 8.0 g of menthol are added to the mixture. The flavour-containing mixture is homogenized for 3 minutes. Subsequently, the resulting aqueous composition is cast on a paper wrapper comprising graphite particles located on a metallic tray, left to jellify and dried in a still oven at 65 degrees Celsius. A flavour material comprising a layer of gellan gum matrix trapping the menthol formulation immobilised on the graphite-containing paper wrapper is obtained.

### Preparation D—Flavour Material Comprising a Menthol Formulation Trapped in a Gellan Gum Polysaccharide Matrix Supported on a Carrier Sheet Material (Homogenised Tobacco Material)

100 g of water are heated to about 60 degrees Celsius and 3.0 g of gellan gum are added to the water bath. The resulting mixture is homogenized and heated to a temperature in the range from 80 to 85 degrees Celsius and kept at this temperature for 5 minutes. The mixture is subsequently cooled down to a temperature in the range from 70 to 75 degrees Celsius and 0.1 g of lecithin and 8.0 g of menthol are added to the mixture. The flavour-containing mixture is homogenized for 3 minutes. Subsequently, the resulting aqueous composition is cast on a sheet of homogenised tobacco material comprising graphite particles located on a metallic tray, left to jellify and dried in a still oven at 65 degrees Celsius. A flavour material comprising a layer of gellan gum matrix trapping the menthol formulation immobilised on the graphite-containing homogenised tobacco material is obtained.

### Preparation E—Flavour Material Comprising a Menthol Formulation Trapped in a Gellan Gum-Guar Polysaccharide Matrix Supported on a Carrier Sheet Material (Homogenised Tobacco Material)

100 g of water are heated to about 60 degrees Celsius and 1.0 g of gellan gum are added to the water bath. The resulting mixture is homogenized and heated to a temperature in the range from 80 to 85 degrees Celsius and kept at this temperature for 5 minutes. The mixture is subsequently cooled down to a temperature in the range from 70 to 75 degrees Celsius and 0.1 g of lecithin and 8.0 g of menthol are added to the mixture. The flavour-containing mixture is homogenized for 3 minutes. Subsequently, 2.0 g of guar are added to the mixture, which is then homogenised again for another 3 minutes. Subsequently, the resulting aqueous composition is cast on a sheet of homogenised tobacco material comprising graphite particles and located on a metallic tray, left to jellify and dried in a still oven at 65 degrees Celsius. A flavour material comprising a layer of gellan gum/guar matrix trapping the menthol formulation immobilised on the graphite-containing homogenised tobacco material is obtained.

### Preparation F—Flavour Material Comprising a Menthol Formulation Trapped in a Gellan Gum-Alginate Matrix Supported on a Carrier Sheet Material (Homogenised Tobacco Material)

100 g of water are heated to about 60 degrees Celsius and 2.0 g of gellan gum and 0.5 g of alginate are added to the water bath. The resulting mixture is homogenized and heated to a temperature in the range from 90 to 95 degrees Celsius and kept at this temperature for 5 minutes. The mixture is subsequently cooled down to a temperature in the range from 70 to 75 degrees Celsius and 0.1 g of lecithin and 8.0 g of menthol are added to the mixture. The flavour-containing mixture is homogenized for 3 minutes. Subsequently, 2.0 g of guar are added to the mixture, which is then homogenised again for another 3 minutes. Subsequently, the resulting aqueous composition is cast onto a sheet of homogenised tobacco material comprising graphite particles and located on a metallic tray, left to jellify and dried in a still oven at 65 degrees Celsius. A flavour material comprising a layer of gellan gum/alginate matrix trapping the menthol formulation immobilised on the graphite-containing homogenised tobacco material is obtained.

### Preparation G—Aerosol-Generating Article Comprising a Flavour Material Produced According to Preparation A

An aerosol-generating article having the overall structure and geometry shown in FIG. 1 was prepared.

An amount of flavour material produced according to Preparation A making up for an overall content of menthol of 5 mg was provided at a location immediately upstream of the aerosol-generating element. An amount of flavour material produced according to Preparation A making up for an overall content of menthol of 10 mg was provided at a location along the hollow tubular element immediately downstream of the aerosol-generating element.

### Preparation H—Aerosol-Generating Article Comprising a Flavour Material Produced According to Preparation A

An aerosol-generating article having the overall structure and geometry shown in FIG. 1 was prepared.

An amount of flavour material produced according to Preparation A making up for an overall content of menthol of 5 mg was provided at a location immediately upstream of the aerosol-generating element. An amount of flavour material produced according to Preparation A making up for an overall content of menthol of 5 mg was provided at a location along the hollow tubular element immediately downstream of the aerosol-generating element. Additionally, an amount of flavour material produced according to Preparation A making up for an overall content of menthol of 5 mg was provided at a location within the aerosol-generating substrate.

### Preparation I—Aerosol-Generating Article Comprising a Flavour Material Produced According to Preparation A

An aerosol-generating article having the overall structure and geometry shown in FIG. 1 was prepared.

An amount of flavour material produced according to Preparation A making up for an overall content of menthol of 15 mg was provided at a location along the hollow tubular element immediately downstream of the aerosol-generating element.

### Comparative Preparation A—Flavour Material Comprising a Menthol Formulation Trapped in a Gellan Gum Polysaccharide Matrix Supported on a Carrier Sheet Material (Homogenised Tobacco Material)

100 g of water are heated to about 60 degrees Celsius and 3.0 g of gellan gum are added to the water bath. The resulting mixture is homogenized and heated to a temperature in the range from 80 to 85 degrees Celsius and kept at this temperature for 5 minutes. The mixture is subsequently cooled down to a temperature in the range from 70 to 75 degrees Celsius and 0.1 g of lecithin and 8.0 g of menthol are added to the mixture. The flavour-containing mixture is homogenized for 3 minutes. Subsequently, the resulting aqueous composition is cast onto a sheet of homogenised tobacco material free of graphite particles and located on a metallic tray, left to jellify and dried in a still oven at 65 degrees Celsius. A flavour material comprising a layer of gellan gum matrix trapping the menthol formulation immobilised on the graphite-free homogenised tobacco material is obtained.

### Comparative Preparation B—Flavour Material Comprising a Menthol Formulation Trapped in a Gellan Gum/Guar Polysaccharide Matrix Supported on a Carrier Sheet Material (Homogenised Tobacco Material)

100 g of water are heated to about 60 degrees Celsius and 1.0 g of gellan gum are added to the water bath. The resulting mixture is homogenized and heated to a temperature in the range from 80 to 85 degrees Celsius and kept at this temperature for 5 minutes. The mixture is subsequently cooled down to a temperature in the range from 70 to 75 degrees Celsius and 0.1 g of lecithin and 8.0 g of menthol are added to the mixture. The flavour-containing mixture is homogenized for 3 minutes. Subsequently, 2.0 g of guar are added to the mixture, which is then homogenised again for another 3 minutes. Subsequently, the resulting aqueous composition is cast onto a sheet of homogenised tobacco material free of carbon particles and located on a metallic tray, left to jellify and dried in a still oven at 65 degrees Celsius. A flavour material comprising a layer of gellan gum/guar matrix trapping the menthol formulation immobilised on the graphite-free homogenised tobacco material is obtained.

### Morphologic Characterisation

FIG. 2 shows a scanning electron microscope (SEM) image of the flavour material 50 produced in accordance with Preparation E embedded in a wax. It can be seen from the image that the internal structure of the flavour material includes a matrix 52 with a plurality of small pockets 54 adapted to trap the flavour composition, the pockets 54 being dispersed through the matrix 52. The pockets are relatively uniformly distributed through the material and are relatively consistent in size. The flavour material 50 further comprises a carrier sheet material 56 in the form of a sheet of homogenised tobacco material containing graphite particles, the carrier sheet material 56 supporting the matrix 52. The SEM technology does not allow for the graphite particles to be distinguished from the remainder of the carrier sheet material.

FIG. 3 shows a SEM image of a flavour material 150 produced in accordance with Preparation A embedded in a wax. It can be seen from the image that the internal structure of the flavour material includes a matrix 52 with a plurality of small pockets 54 adapted to trap the flavour composition, the pockets 54 being dispersed through the matrix 52. The domains are relatively uniformly distributed through the material and are relatively consistent in size. In contrast to the flavour material 50 of FIG. 2, the flavour material 150 does not comprise a carrier sheet material supporting the matrix, and carbon particles are embedded in the matrix structure. The SEM technology does not allow for the graphite particles to be distinguished from the remainder of the matrix structure.

### Thermogravimetric Analysis

The flavour release profile of the flavour material produced according to the Preparations above may be analysed in a thermogravimetric analysis (TGA). The TGA test is carried out using a thermogravimetric machine coupled/hyphenated to a mass spectrometer, or similar equipment. In the analysis the flavour material is heated from 25 degrees Celsius to 400 degrees Celsius in an inert nitrogen atmosphere with the temperature being increased at a rate of 15 degrees Celsius per minute and with an air flow of 60 ml per minute. As the temperature is increased, the release of menthol is assessed by detecting the menthol molecules by way of a specific ion representative of menthol.

Data collected carrying out TGA tests on flavour materials in accordance with the invention can be compared with data collected carrying out an equivalent TGA test on the flavourant formulation alone (e.g. pure menthol). One such comparison may provide some information about release mechanisms and dynamics, which may be help fine tune a flavourant release profile when the flavour material is incorporated in an aerosol-generating article.

When heated in the thermogravimetric analysis described, pure menthol was released unimodally between 50 degrees Celsius and 166 degrees Celsius, with a maximum around 138 degrees Celsius.

By contrast, when heated in the thermogravimetric analysis described, the flavour material produced according to Preparation E was found to provide a multi modal release of menthol. A first fraction (about 57 percent) of the menthol was released between 62 degrees Celsius and 239 degrees Celsius, with a local maximum at about 194 degrees Celsius. A second fraction (about 24 percent) of the menthol was released between 240 degrees Celsius and 305 degrees Celsius with a local maximum at about 252 degrees Celsius. A third fraction (about 19 percent) of the menthol was released between 305 degrees Celsius and 387 degrees Celsius with a local maximum at about 344 degrees Celsius.

Release of the first fraction of menthol with a maximum just below 200 degrees Celsius may suggest that some of the menthol formulation is solubilised or relatively weakly immobilised within the flavour material. On the other hand, release of the second fraction of menthol with a maximum around 250 degrees Celsius—a temperature associated with gellan gum thermal degradation—may support the hypothesis that a significant portion of the menthol formulation is trapped within the matrix structure, and has some stronger interaction with the gellan gum in the matrix structure. Release of the third fraction of menthol at even higher temperatures may suggest that the menthol formulation interacts in a different manner with the guar in the matrix structure.

The same TGA test was carried out on a flavour material prepared in accordance with Preparation D. This flavour material was found to provide a bimodal release of menthol. A first, small fraction (about 9 percent) of the menthol was released between about 68 degrees Celsius and about 148 degrees Celsius, with a local maximum around 125 degrees Celsius. A second, much more significant fraction (about 91 percent) of the menthol was released between 230 degrees Celsius and 245 degrees Celsius, with a local maximum at around 242 degrees Celsius.

Release of the first fraction of menthol around 130 degrees Celsius may suggest that a small portion of the menthol formulation contained in the flavour material is not immobilised. On the other hand, the greater part of the menthol formulation contained in the flavour material being released at higher temperatures appears to suggest a stronger interaction with the gellan gum, which results in an effective immobilisation.

A comparison between the menthol release profiles of flavour materials prepared according to Preparations E and D demonstrates that adjusting the composition of the polysaccharide matrix—for example, using gellan gum alone or in combination with another polysaccharide—may help fine tune flavour delivery when the flavour material is incorporated in an aerosol-generating article. In particular, it may be possible to control at what temperature flavour release is initiated and around what temperature flavour release is maximised. Additionally, flavour materials which, like the ones prepared according to Preparations E and D, have different flavour release profiles with local maxima at different temperatures, may be combined in a single aerosol-generating articles to provide an even broader range of flavour delivery options to the consumer.

The same TGA test was carried out on a flavour material prepared in accordance with Comparative Preparation B, which differs from the flavour material prepared according to Preparation E only in that the carrier sheet of homogenised tobacco material does not include the graphite particles. Like the flavour material prepared according to Preparation E, when heated in the thermogravimetric analysis described, the flavour material produced according to Comparative Preparation B was found to provide a multi modal release of menthol. A first fraction (about 41 percent) of the menthol was released in the lower temperature range, then a second fraction (about 34 percent) and a third fraction (about 25 percent) of the menthol were released in the higher temperature intervals.

A comparison between the menthol release profile of Preparation E and Comparative Preparation B suggests that the inclusion of the carbon particles in the flavour material tends to enhance the thermal release of menthol at lower temperatures. In particular, a shift of about 5 degrees Celsius towards lower temperatures was observed, the local maximum associated with release of the first fraction of menthol being observed at about 199 degrees Celsius for the flavour material produced in accordance with Comparative Preparation B.

Additional tests carried out under isothermal conditions have confirmed that, especially at lower temperatures, the flavour material produced in accordance with Preparation E releases significantly more menthol than the flavour delivery produced in accordance with Comparative Preparation B. At 150 degrees Celsius, the flavour material produced in accordance with Preparation E released about 1.73 times as much menthol as the flavour delivery produced in accordance with Comparative Preparation B. At 180 degrees Celsius, the flavour material produced in accordance with Preparation E released about 1.5 times as much menthol as the flavour delivery produced in accordance with Comparative Preparation B. This appears to confirm that supply of heat is made more effective by the presence of the carbon particles, presumably as they enhance heat transfer by conduction and facilitate a more homogenous temperature distribution throughout the flavour material. As a consequence, a greater portion of the menthol is brought more quickly to a condition wherein it is released from the flavour material.

The same TGA test described above was carried out on a flavour material prepared in accordance with Comparative Preparation A, which differs from the flavour material prepared according to Preparation D only in that no graphite particles are included in the favour delivery material. Like the flavour material prepared according to Preparation D, when heated in the thermogravimetric analysis described, the flavour material produced according to Comparative Preparation A was found to provide a bimodal release of menthol.

The menthol release profile of Preparation D was compared with the menthol release profile of Comparative Preparation A by plotting the cumulative amount of menthol released by each flavour material side by side. The results of this comparison suggest that the inclusion of the carbon particles in the flavour material tends to enhance the thermal release of menthol. In particular, a shift of about 5 degrees Celsius or more towards lower temperatures for the flavour material produced according to Preparation D was observed. For example, 40 percent of the menthol contained in the flavour material produced according to Preparation D had been released when the flavour material reached 240 degrees Celsius, whereas the flavour material produced according to Comparative Preparation A only reached the same 40 percent release threshold at 245 degrees Celsius. Similarly, 60 percent of the menthol contained in the flavour material produced according to Preparation D had been released when the flavour material reached 243 degrees Celsius, whereas the flavour material produced according to Comparative Preparation A only reached the same 40 percent release threshold at about 249 degrees Celsius.

### Thermal Stability

The thermal stability under stress conditions of a flavour material in accordance with the present invention may be assessed by ageing the flavour material at a constant temperature and monitoring its weight loss over time. To this purpose samples of the flavour material cut into regular and homogenously sized pieces are weighed and distributed in a series of Schott glass open bottles. The samples are aged in a laboratory oven set at 50 degrees Celsius for a period of two weeks. For the flavour material produced in accordance with Preparation E, a weight loss of about 24 percent was measured at the end of the test. It is hypothesised that such weight loss value accounts not only for some migration of flavour species, but also for losses of humidity and glycerol, and so it is considered to be satisfactory.

### Aerosol-Generating Article Flavour Delivery Assessment

Flavour delivery of an aerosol-generating article incorporating a flavour material in accordance with the present invention may be assessed by heating the aerosol-generating article in a commercially available, compatible heating device and measuring the menthol delivered at the mouth end of the article with every puff.

In more detail, the products released with each puff from the aerosol-generating article heated by the heating device may be analysed using Proton Transfer Mass Spectrometry (PTR-MS).

The puff-by-puff menthol delivery of an aerosol-generating article produced in accordance with Preparations G, H and I was measured. The three aerosol-generating articles tested have substantially the same overall structure and geometry and contain the same overall amount of flavour material. However, the flavour material is arranged and distributed at different locations within the aerosol-generating article, and so the experiments allowed the inventors to assess if and how the menthol release and delivery vary depending on the positioning of the flavour material. Transfer rates of 7 percent, 10 percent, and 6 percent, respectively, were observed for the aerosol-generating articles prepared in accordance with Preparations G, H and I.

The aerosol-generating articles prepared in accordance with Preparations G and I, which do not contain any flavour material at a location within the aerosol-generating substrate, exhibited similar menthol transfer rates. This experimental finding confirmed that providing flavour materials of the type described above at locations upstream or downstream of the aerosol-generating element is associated with satisfactory flavourant transfer rates during use.

The slightly higher transfer rate measured for the aerosol-generating article prepared in accordance with Preparation H suggests that while the provision of flavour material at a location within the aerosol-generating substrate—in line with solutions known from the prior art—does contribute to the overall flavour transfer rate.

However, the fact that the aerosol-generating article prepared in accordance with Preparation H does not outperform the aerosol-generating articles prepared in accordance with Preparations G and I would appear to suggest that incorporation of the flavour materials described herein—particularly those flavour materials displaying enhanced flavour delivery at lower temperatures—at locations other than within the aerosol-generating substrate can be used to adjust and tailor flavour release characteristics in ways that were not possible with aerosol-generating articles known in the art.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±5% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating article for generating an aerosol upon heating, the aerosol-generating article comprising:
an aerosol-generating element comprising a rod of aerosol-generating substrate circumscribed by a wrapper;
a downstream section provided immediately downstream of the aerosol-generating element and extending from a downstream end of the aerosol-generating element to a downstream end of the aerosol-generating article;
an upstream section provided immediately upstream of the aerosol-generating element and extending from an upstream end of the aerosol-generating element to an upstream end of the aerosol-generating article, the upstream section comprising an upstream element formed from a tow of cellulose acetate fibres;
pieces of a flavour material combined into the tow of cellulose acetate fibres,
wherein the flavour material comprises: a polysaccharide matrix structure comprising gellan gum and emulsifier, and a flavourant formulation dispersed within the polysaccharide matrix structure, and
wherein the flavourant formulation is at least partly trapped within the polysaccharide matrix structure and releasable from the polysaccharide matrix structure upon heating of the flavour material.

17. The aerosol-generating article according to claim 16,
wherein the downstream section comprises a hollow tubular element provided immediately downstream of the aerosol-generating element, an upstream end of the hollow tubular element abutting a downstream end of the aerosol-generating element, and
wherein the flavour material is provided in the hollow tubular element.

18. The aerosol-generating article according to claim 16,
wherein the upstream section comprises an upstream element provided immediately upstream of the aerosol-generating element, a downstream end of the upstream element abutting an upstream end of the aerosol-generating element, and
wherein the flavour material is provided in the upstream element.

19. The aerosol-generating article according to claim 16, wherein the polysaccharide matrix structure comprises gellan gum as the sole polysaccharide or gellan gum in combination with at least a further polysaccharide selected from the group consisting of guar, tamarind gum, sodium alginate, xanthan gum, sodium carboxymethyl cellulose, and hydroxypropyl methyl cellulose.

20. The aerosol-generating article according to claim 19, wherein the gellan gum accounts for from 5 percent by weight to 99.9 percent by weight of the flavour material on a dry weight basis.

21. The aerosol-generating article according to claim 16, further comprising a polyol having the formula CₙH₂ₙ₊₂Oₙ.

22. The aerosol-generating article according to claim 21,
wherein the polyol is selected from the group consisting of glycerol, sorbitol, xylitol, mannitol, and erythritol, or
wherein the polyol makes up from 0.01 percent by weight to 20 percent by weight of the flavour material on a dry weight basis or both.

23. The aerosol-generating article according to claim 16, wherein the flavour material further comprises fibres.

24. The aerosol-generating article according to claim 23, wherein the fibres make up from 0.01 percent by weight to 10 percent by weight of the flavour material on a dry weight basis.

25. The aerosol-generating article according to claim 16,
wherein the flavour material further comprises a carrier material, and
wherein the polysaccharide matrix structure and the flavourant formulation are supported by the carrier material.

26. The aerosol-generating article according to claim 25, wherein the carrier material is a sheet of homogenised tobacco material or a sheet of plug paper wrapper material.

27. The aerosol-generating article according to claim 16, further comprising a ventilation zone at a location along the hollow tubular element, the ventilation zone being configured to enable ingress of air into an axial lumen of the hollow tubular element.

28. The aerosol-generating article according to claim 16, wherein the aerosol-generating substrate comprises a tobacco material.

29. The aerosol-generating article according to claim 28, wherein the tobacco material comprises a sheet of homogenised tobacco material or one or more of tobacco cut filler, cut reconstituted tobacco, and cut homogenised tobacco material.

30. An aerosol-generating system, comprising:
an aerosol-generating article according to claim 16; and
an aerosol-generating device configured to heat the aerosol-generating substrate of the aerosol-generating article,
wherein the aerosol-generating device comprises a housing defining a cavity configured to receive the aerosol-generating article.

31. The aerosol-generating system according to claim 30, wherein the aerosol-generating device further comprises a heater element configured to be inserted into the aerosol-generating element when the aerosol-generating article is received within the cavity.

32. The aerosol-generating system according to claim 30,
wherein the aerosol-generating article further comprises a susceptor element provided at a location within the aerosol-generating element, and
wherein the aerosol-generating device further comprises an inductor coil positioned on or within the housing, and a power supply connected to the inductor coil and configured to provide a high frequency oscillating current to the inductor coil.

33. The aerosol-generating system according to claim 30, wherein the aerosol-generating device further comprises a heater element located about a perimeter of the cavity and configured to heat the aerosol-generating substrate of the aerosol-generating article from an exterior of the aerosol-generating element of the aerosol-generating article.
